(19) United States
(12) Patent Application Publication
(10) Pub. No.: US 2006/0191501 A1
(43) Pub. Date: Aug. 31, 2006

(54) Flywheel vane combustion engine

(76) Inventor: Donald L. Adle, Farmington Hills, MI (US)

Correspondence Address: Donald L. Adle, 29510 Greenboro, Farmington Hills, MI, 48334, US

(21) Appl. No.: 11/318,645

(22) Filed: Dec. 21, 2005

Related U.S. Application Data
(63) Continuation-in-part of application No. 10/724,499, filed on Dec. 1, 2003.

(51) Int. Cl. F01B 3/00; F16J 1/24

(52) U.S. Cl. 123/45 R

(57) ABSTRACT

This Invention relates generally to the free-piston type internal combustion engine, using air by compressing the air, moving the compressed air outward onto the flywheel eba-vane 244, therefor moving the yyy-flywheel 240 in a rotary motion. Transferring energy from the yyy-flywheel 240 directly to the drive eca-shaft 246. The xxx-piston 138 move fore and aft, within the www-cylinder 112, from the combustion aba-chamber 118 to the combustion bba-chamber 128. The exhaust holding abd-area 252 and the exhaust holding bbd-area 258 is an area within the xxx-piston 138 that would be holding some of the exhaust before expelling the exhaust. By holding some of the exhaust this would help the xxx-piston 138 to hold and keep pressure on the air/fuel before air/fuel explodes within the combustion aba-chamber 118 or the combustion bba-chamber 128. The piston aka-rod 148, attached to the xxx-piston 138 at one end, the air ara-piston 172 at the other end, resulting in the fore and aft movement of the air ara-piston 172. The piston bka-rod 154, attached to the xxx-piston 138 at one end, the air bra-piston 178 at the other end, resulting in the fore and aft movement of the air bra-piston 178. The air ara-piston 172 move fore on the outward stroke and aft on the inward stroke compressing the air, the compressed air is pushing and pulling the flywheel eba-vane 244 in a rotary motion. The air bra-piston 178 move fore on the outward stroke and aft on the inward stroke compressing the air, the compressed air is pushing and pulling the flywheel eba-vane 244 in a rotary motion. Using compressed air movement to push and pull the flywheel eba-vane 244, attached to the yyy-flywheel 240 in a rotary motion. The yyy-flywheel 240, attached to the drive eca-shaft 246, rotating the drive eca-shaft 246.

### CROSS-REFERENC TO RELEATED APPLICATIONS REFERENCE TO MICROFICHE APPENDIX

Not applicable.

### CROSS REFERENCE TO RELATED APPLICATIONS

Dainton device (U.S. Pat. No. 1,802,881 issued April 1931). Wilcoxson device (U.S. Pat. No. 2,350,005 issued February 1940). Benoit device (U.S. Pat. No. 3,068,639 issued September 1961). Rinker device (U.S. Pat. No. 3,710,569 issued September 1973). Pais device (U.S. Pat. No. 3,757,515 issued September 1973). Wallis device (U.S. Pat. No. 3,978,827 issued September 1976). Heaton device (U.S. Pat. No. 4,344,288 issued August 1982). Benaroya device (U.S. Pat. No. 4,403,577 issued September 1983). Southard device (U.S. Pat. No. 4,733,534 issued March 1988). Heaton device (U.S. Pat. No. 4,449,488 issued May 1984). David device (U.S. Pat. No. 4,561,252 issued December 1985). Chaneac device (U.S. Pat. No. 4,848,282 issued July 1989). Hammett device (U.S. Pat. No. 4,920,928 issued May 1990). Wilson device (U.S. Pat. No. 4,951,618 issued August 1990). Han device (U.S. Pat. No. 5,036,667 issued August 1991). Ohori device (U.S. Pat. No. 5,669,340 issued September 1961). Han device (U.S. Pat. No. 5,678,522 issued October 1997). Bailey device (U.S. Pat. No. 6,205,961 issued March 2001). Valentin device (U.S. Pat. No. 6,293,231 issued September 2001). Young device (U.S. Pat. No. 6,408,717 issued June 2002). Nagel device (U.S. Pat. No. 6,449,940 issued September 2002). Morikami device (U.S. Pat. No. 6,450,846 issued September 2002). Adle device (U.S. Patent Application Publication No. 2005/0072150 A1-Pub. Date: Apr. 7, 2005). Application Ser. No. 10/367,056file date; Feb. 14, 2003.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING APPENDIX

Not applicable.

### BACKGROUND OF INVENTION

1. This Invention relates generally to the free-piston type internal combustion engine that connected to a flywheel, working as a unit and enclosed within the internal combustion engine. This invention particular innovations which improve controllability and efficiency of the free-piston engine combining with a flywheel that enclosed within the engine. Within the engine using one hot gas cylinder housing with two combustion chambers with one piston along with two air cylinder housing and a enclosed flywheel. The piston along with two piston rods attached and extended out though an rod opening on each side of the cylinder. One of the rod attached to the hot gas piston on one side of the piston and to an air piston at the other end. The other rod would be attached to the same hot gas piston on the other side and this rod would be attached to the other air piston. Said air pistons are house within said air cylinders.

2. Invention is directed to an internal combustion engine, which is well known. There are engines with a combustion chamber that are with its piston and rod rigidly attached to the crankshaft. Free-piston engine moves freely and independently of main shaft of the engine. Advantages of a free-piston engine that its piston not being rigidly attached to a crankshaft connected by a rod. Cylinders provide the energy for compression stroke for the pistons.

3. Internal-combustion engine, fuel-air mixture is burned in the engine proper. Hot gaseous products of combustion act directly on the surfaces of its moving parts, such as those of pistons. This invention using one cylinder with one piston for the hot gaseous in the combustion chamber along with using two air cylinders with its air pistons that uses air. The hot gaseous would drive the piston within the cylinder housing back/fore, therefore drive the rods that connected to the piston at one end and the air piston at the other end. The hot gaseous piston would have a exhaust holding area within the piston. The holding area would be used to hold some of the exhaust as the other part of this exhaust within the combustion chamber would hold the pressure within the other combustion chamber within the cylinder. This pressure on the piston would hold the piston in place with its air-fuel mix before it explodes. Within the air cylinder chamber with its air piston would be using air. The air cylinder chambers with the air pistons inside, pushing air outward onto and drawing air inward off the enclosed flywheel vane, connected to the flywheel. Therefore rotating the flywheel in a rotary motion. Using a flywheel along with a free moving hot gaseous piston, moving fore and aft, from combustion chamber to combustion chamber, pushing/pulling two air pistons that would be pushing/drawing air onto/from the flywheel vane, therefore rotating the flywheel in a rotary motion. This will reduce toxic emissions, weight and size of such engines.

4. Free-piston internal-combustion engines having a cylinder and one or more reciprocation pistons therein. One piston at least of which is movable freely and independently of the main shaft. Engine on the stroke of such piston immediately following ignition of the charge. Burned gases during which stroke the energy is stored. Energy is thereafter transferred to main shaft of the engine. Energy is ordinarily stored by forcing piston against pressure of the atmosphere. Therefor stored energy is ordinarily transferred to the main shaft by securing piston thereto by means of a suitable clutch. Such energy provided with suitable converting mechanism upon its return stroke. This invention there an advantageous application using one cylinder, with two combustion chamber with one piston within freely moving fore and aft, from combustion chamber to combustion chamber.

5. Cylinders provide the energy for compression stroke for the pistons. The cylinder closed at both ends having two combustion chambers house within. Combustion act to move the piston fore and aft from combustion chamber to combustion chamber. Cylinder of an internal-combustion engine is usual closed at one end by a plate called a head and open at the other end. Permitting free oscillation of the connection rod, which joins piston to crankshaft. This Invention relates to the free-piston type internal combustion engine with the cylinder closed at both ends, having two combustion chambers house within. Cylinder closed at both ends using a free moving piston, being able to move fore and aft from combustion chamber to combustion.

6. This invention the air outline is a pipe for conveying air from the air cylinder chamber to the flywheel vane. Air outline door house inside the air outline. A air outline door control the outflow and inflow of air by using a air outline door. Air pressure produced within the air cylinder by the air piston as air is pushed outward though a air outline inlet opening, therefore pushing the air outward into the air outline, that would push the air outward onto the flywheel vane.

7. This invention the air pistons being house within air cylinders. Air piston outward stroke, moves outward toward the enclosed flywheel vane pushing air outward onto the flywheel vane. On the outward stroke the air outline door would open within the air outline and on the inward stroke would close. The out going air pressure pushes on the air outline door therefore opening the air outline door and opening up the air flow. The inward stroke with its incoming air pressure would close the air outline door and close off the air flow. Air outline door remains opened during outward stroke and remains closed on the inward stroke. The outward stroke of the air piston would push air onto the flywheel vane and move the flywheel forward in a rotary motion.

8. This invention the air inline is a pipe for conveying air from the flywheel vane, to the air cylinder chamber. Air inline door house inside the air inline. A air inline door control the inflow and outflow of air by using a air inline door. Air being drawn into the air cylinder by the air piston inward stroke, drawing air into the air inline off the flywheel vane, therefore drawing the air inward into the air inline, that would draw the air inward into the air cylinder chamber.

9. This invention air pistons being house within air cylinders. Air piston inward stroke, moves inward into the air clinder drawing air from the enclosed flywheel vane, drawing air off the flywheel vane into the air clinder chamber. On the inward stroke the air inline door would open within the air inline and on the outward stroke would close. The incoming air pressure pushes on the air inline door therefore opening the air inline door and opening up the air flow. The outward stroke with its out going air pressure would push on the inline door therefore closing the inline door and closing off the air flow. Incoming air pressure would open the air inline door by air being drawn into the inline. Air inline door remains opened during inward stroke and remains closed on the outward stroke. The inward stroke of the air piston would draw air off the flywheel vane and move the flywheel forward in a rotary motion.

10. Flywheel is a rotation wheel used to minimize variations in angular velocity and revolutions per minute. Flywheel usual come into play only after crankshaft or other moving parts ends their movements. Flywheel is a wheel attached to a rotating shaft. Smoothing out delivery of power from a motor to a machine. Inertia of the flywheel opposes and moderates fluctuations in speed of engine. Flywheel stores the excess energy for intermittent use. The flywheel smoothes out pulses of energy provided by combustion.

11. This invention a flywheel along with using a free-piston type internal combustion engine with the use of air, by pushing air outward onto a flywheel vane attached to a flywheel, this would initiated, controlled and transmits power to the drive shaft. By using one cylinder with two combustion chamber that has only one piston with its exhaust holding area within moving fore and aft from combustion chamber to combustion. By using two air cylinders with a air piston in each one. One air piston would be pushing air outward onto the flywheel vane attached to the flywheel, the other air piston would be drawing air off the flywheel vane. The air coming onto the flywheel vane would be before the air would be drawn off the flywheel vane, therefore move the flywheel forward in a rotary motion. This would take advantage of bypassing the use of having a crankshaft rigidly attached to a piston connected by a rod.

12. Simple concept of free-piston internal combustion engines is transferring combustion energy direct into mechanical energy. Flywheels rarely utilized due to its inability to procure energy. Therefore not having control in their operating characteristics particular, free-piston type internal combustion engine and using the flywheel sufficiently. This invention there an advantageous application, using its free-piston type internal combustion engine, by using air to transmit energy onto the flywheel vanes, attached to the flywheel.

### BRIEF SUMMARY OF THE INVENTION

The present invention substantially departs from conventional concepts and designs of prior art and relates generally to the free-piston type internal combustion engine. This invention uses a engine that enclosed with a yyy-flywheel 240 within, with the use of compressed air that being push first onto and then draw said air off a flywheel eba-vane 244 on said yyy-flywheel 240.

The pushing of said air onto said flywheel eba-vane 244 at one place and then drawing said air off after that place on said flywheel eba-vane 244, this would move said yyy-flywheel 240 in a rotary motion. Said yyy-flywheel 240, attached to a drive eca-shaft 246, would rotates said drive eca-shaft 246 in a rotary motion, converting energy into mechanical energy or work.

A flywheel vane combustion engine 110 utilizing a www-cylinder 112 enclosed within said engine. Said www-cylinder 112 would have a combustion aba-chamber 118 at one end and a combustion bba-chamber 128 at the other end. Said combustion aba-chamber 118 and said combustion bba-chamber 128 would have a xxx-piston 138 with a piston aia-head 144 at one end and another a piston bia-head 146 at the other end. Said xxx-piston 138 would be between said combustion aba-chamber 118 and said combustion bba-chamber 128 enclosed within said www-cylinder 112. Said xxx-piston 138 would have a exhaust holding abd-area 252 near one end and a exhaust holding bbd-area 258 near the other end. Said xxx-piston 138 would move fore and aft from said combustion aba-chamber 118 and said combustion bba-chamber 128 within said www-cylinder 112. Said exhaust holding abd-area 252 and said exhaust holding bbd-area 258 is an area within said xxx-piston 138 that would be holding the exhaust before expelling said exhaust. Some of the exhaust would help said xxx-piston 138 to hold and keep pressure on the air/fuel before air/fuel explodes. Some of said exhaust would be held within said exhaust holding abd-area 252 or said exhaust holding bbd-area 258 and the other part of this exhaust would help to hold the pressure on the air/fuel before air/fuel explodes within said combustion aba-chamber 118 or said combustion bba-chamber 128.

Said xxx-piston 138 would have a piston aka-rod 148 attached on one side of said xxx-piston 138 than on the other side of said xxx-piston 138 would also be a piston bka-rod 154 attached. Said piston aka-rod 148 and said piston bka-rod 154 attached to said xxx-piston 138 move fore and aft within the movement of said xxx-piston 138. At the other end of said piston aka-rod 148 there would be attached a air ara-piston 172. Said air ara-piston 172 would be lying within a air aoa-cylinder 160. Said piston bka-rod 154 that is attached to the other side of said xxx-piston 138 would be attached to a air bra-piston 178. Said air bra-piston 178 would be lying within a air boa-cylinder 166.

Said flywheel vane combustion engine 110 utilizing said air aoa-cylinder 160 with a air aua-outline 184 and a air cba-inline 212 enclosed within said engine.

Said flywheel vane combustion engine 110 utilizing said air boa-cylinder 166 with a air bua-outline 198 and a air dba-inline 226 enclosed within said engine.

Said air ara-piston 172 would move fore and aft within said air aoa-cylinder 160. Said air ara-piston 172 within a air cylinder apa-chamber 162 would push air into said air aua-outline 184 or draw air from said air cba-inline 212.

Said air bra-piston 178 would move fore and aft within said air boa-cylinder 166. Said air bra-piston 178 within a air cylinder bpa-chamber 168 would push air into said air bua-outline 198 or draw air from said air dba-inline 226.

Said air aua-outline 184, this being a pipe for conveying air from said air cylinder apa-chamber 162 onto said flywheel eba-vane 244. Said air ara-piston 172 would move air on its forward movement, pushing this air within said air cylinder apa-chamber 162 into said air aua-outline 184. Air within said air aua-outline 184 would than be pushed onto said flywheel eba-vane 244.

Said air cba-inline 212, this being a pipe for conveying air from said flywheel eba-vane 244 into said air cylinder apa-chamber 162. Said air ara-piston 172 would draw air off said flywheel eba-vane 244 on its backward movement, this would be drawing said air into said air cba-inline 212. Air within said air cba-inline 212 than would be drawn into said air cylinder apa-chamber 162.

Said air bua-outline 198, this being a pipe for conveying air from said air cylinder bpa-chamber 168 onto said flywheel eba-vane 244. Said air bra-piston 178 would move air on its forward movement, pushing this air within said air cylinder bpa-chamber 168 into said air bua-outline 198. Air within said air bua-outline 198 would than be pushed onto said flywheel eba-vane 244.

Said air dba-inline 226, this being a pipe for conveying said air from said flywheel eba-vane 244 into said air cylinder bpa-chamber 168. Said air bra-piston 178 would draw air off said flywheel eba-vane 244 on its backward movement, this would be drawing said air into said air dba-inline 226. Air within said air dba-inline 226 than would be drawn into said air cylinder bpa-chamber 168.

Said xxx-piston 138 on the inward movement into said combustion aba-chamber 118 would have said air ara-piston 172 draw air into said air cylinder apa-chamber 162. Said xxx-piston 138 on the outward movement away from said combustion aba-chamber 118 would have said air ara-piston 172 push air out of said air cylinder apa-chamber 162.

Said xxx-piston 138 on the inward movement into said combustion bba-chamber 128 would have said air bra-piston 178 draw air into said air cylinder bpa-chamber 168. Said xxx-piston 138 on the outward movement away from said combustion bba-chamber 128 would have said air bra-piston 178 push air out of said air cylinder bpa-chamber 168.

Said flywheel vane combustion engine 110 utilizing said yyy-flywheel 240 enclosed within said engine. Said yyy-flywheel 240 with said flywheel eba-vane 244 with a outer flywheel eaa-edge 242 would be lying near a air outline awa-outlet 188 of said air aua-outline 184, a air inline cca-inlet 214 of said air cba-inline 212, a air outline bwa-outlet 202 of said air bua-outline 198 and a air inline dca-inlet 228 of said air dba-inline 226. Said yyy-flywheel 240 would have said drive eca-shaft 246 attached at the center of said yyy-flywheel 240.

With the movement of said xxx-piston 138 away from said combustion aba-chamber 118, air from said air aua-outline_184 would be pushed onto said flywheel eba-vane 244 and at the same time air would be drawn off said flywheel eba-vane 244 with said air being drawn into said air dba-inline 226. At this time said air would be closed off from entering said air bua-outline 198 and said air cba-inline 212.

With the movement of said xxx-piston 138 away from said combustion bba-chamber 128, air from said air bua-outline 198 would be pushed onto said flywheel eba-vane 244 and at the same time air would be drawn off said flywheel eba-vane 244 with said air being drawn into said air cba-inline 212. At this time said air would be closed off from entering said air aua-outline 184 and said air dba-inline 226.

### BRIEF DESCRIPTION OF THE DRAWING

This invention relates to apparatus and methods.

FIG. 1 is a perspective view of Flywheel vane Combustion Engine showing drive eca-shaft 246 location.

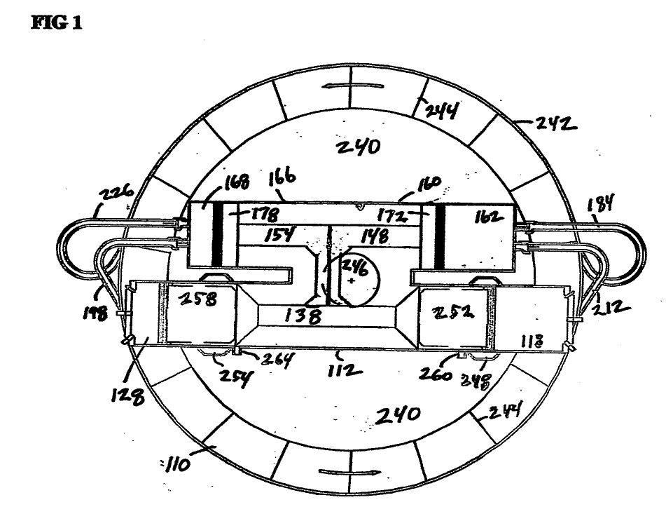

FIG. 2 is a perspective view of Flywheel vane Combustion Engine not showing drive eca-shaft 246 location.

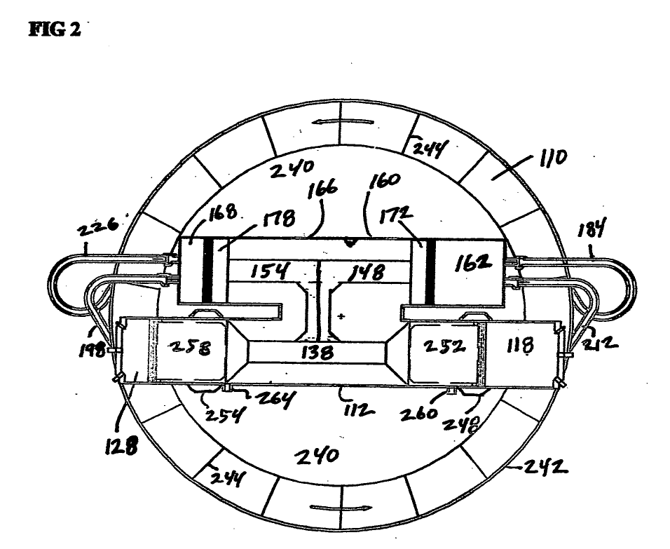

FIG. 3 is a perspective view of Flywheel vane Combustion Engine showing aka-rod 148, piston bka-rod 154, air ara-piston 172, air bra-piston 178, xxx-piston 138, exhaust holding abd-area 252, exhaust holding bbd-area 258, www-cylinder 112, combustion aba-chamber 118, combustion bba-chamber 128, air aoa-cylinder 160, air boa-cylinder 166, air cylinder apa-chamber 162, and air cylinder bpa-chamber 168.

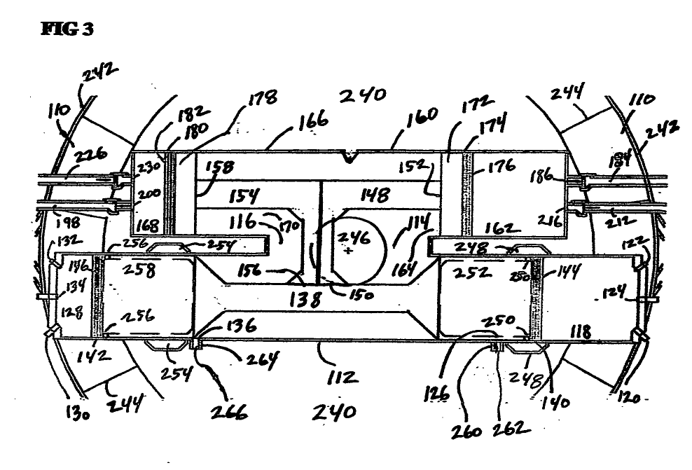

FIG. 4 is a perspective view of Flywheel vane Combustion Engine showing piston aka-rod 148, piston bka-rod 154, air ara-piston 172, air bra-piston 178, xxx-piston 138, exhaust holding abd-area 252, and exhaust holding bbd-area 258.

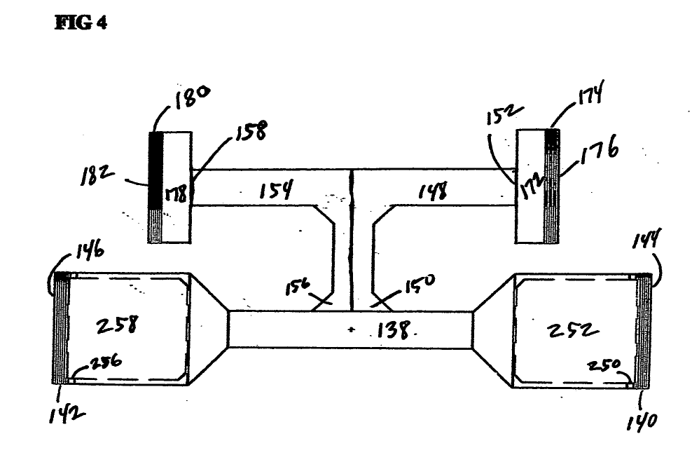

FIG. 5 is a perspective view of Flywheel vane Combustion Engine showing www-cylinder 112, combustion aba-chamber 118, combustion bba-chamber 128, air aoa-cylinder 160, air boa-cylinder 166, air cylinder apa-chamber 162, and air cylinder bpa-chamber 168.

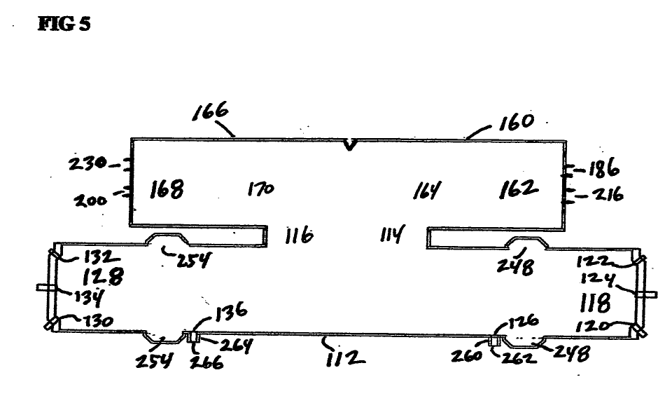

FIG. 6 is a perspective view of Flywheel vane Combustion Engine showing air aoa-cylinder 160, air cylinder apa-chamber 162, air cba-inline 212, air inline cfa-door 220, air aua-outline 184, and air outline aya-door 192.

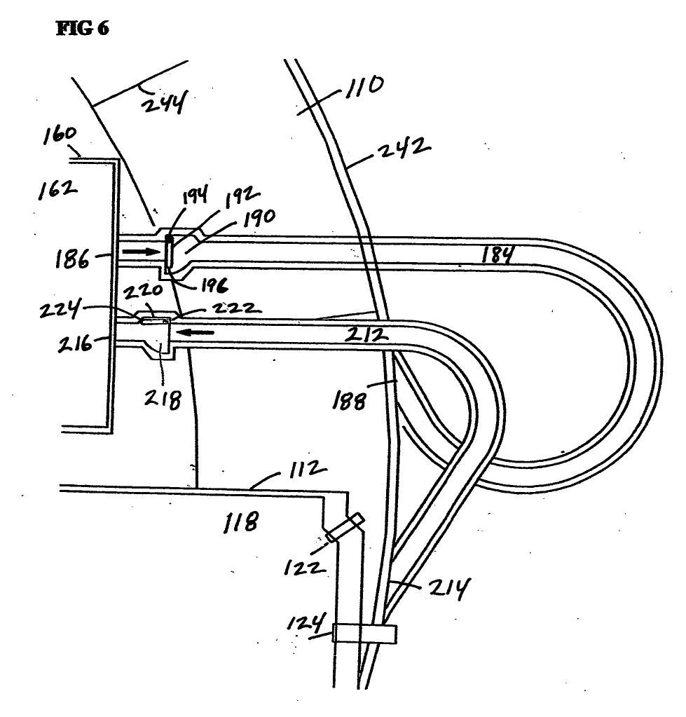

FIG. 7 is a perspective view of Flywheel vane Combustion Engine showing air boa-cylinder 166, air cylinder bpa-chamber 168, air dba-inline 226, air inline dfa-door 234, air bua-outline 198, and air outline bya-door 206.

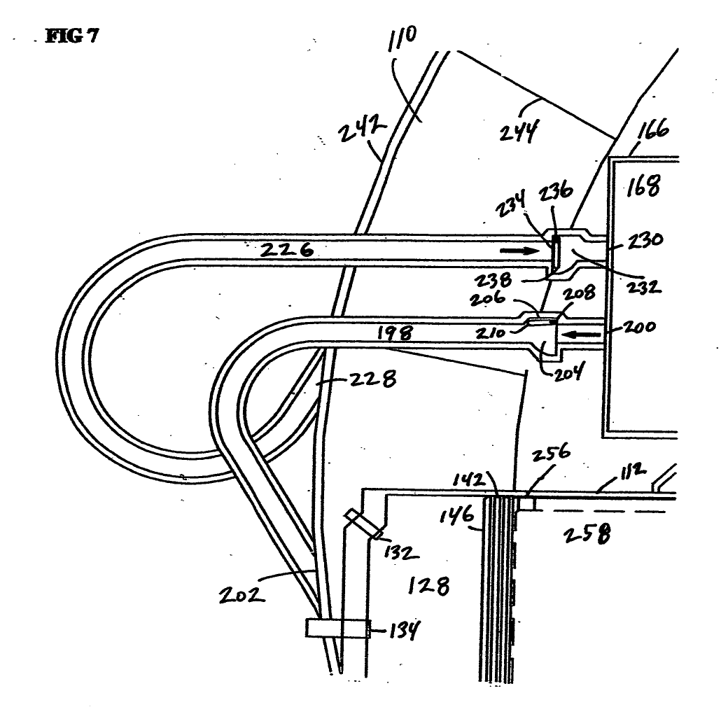

This is in accordance with principles of the present invention.

### REFERENCE NUMERALS IN DRAWINGS

110 flywheel vane combustion engine
112 www-cylinder 114 cylinder aaa-opening
116 cylinder baa-opening 118 combustion aba-chamber
120 aca-sensor 122 ada-injector
124 spark aea-plug 126 exhaust afa-inlet
128 combustion bba-chamber 130 bca-sensor
132 bda-injector 134 spark bea-plug
136 exhaust bfa-inlet 138 xxx-piston
140 piston aga-ring 142 piston bga-ring
144 piston aia-head 146 piston bia-head
148 piston aka-rod 150 rod ama-point p0 152 rod ana-point 154 piston bka-rod
156 rod bma-point 158 rod bna-point
160 air aoa-cylinder 162 air cylinder apa-chamber
164 air cylinder aqa-opening 166 air boa-cylinder
168 air cylinder bpa-chamber 170 air cylinder bqa-opening
172 air ara-piston 174 air piston asa-ring
176 air piston ata-head 178 air bra-piston
180 air piston bsa-ring 182 air piston bta-head
184 air aua-outline 186 air outline ava-inlet
188 air outline awa-outlet 190 air outline axa-chamber
192 air outline aya-door 194 air outline aza-hinge
196 air outline door caa-vane 198 air bua-outline
200 air outline bva-inlet 202 air outline bwa-outlet
204 air outline bxa-chamber 206 air outline bya-door
208 air outline bza-hinge 210 air outline door daa-vane
212 air cba-inline 214 air inline cca-inlet
216 air inline cda-outlet 218 air inline cea-chamber
220 air inline cfa-door 222 air inline cga-hinge
224 air inline door cha-vane 226 air dba-inline
228 air inline dca-inlet 230 air inline dda-outlet
232 air inline dea-chamber 234 air inline dfa-door
236 air inline dga-hinge 238 air inline door dha-vane
240 yyy-flywheel 242 outer flywheel eaa-edge
244 flywheel eba-vane 246 drive eca-shaft
248 chamber abb-outlet 250 exhaust abc-inlet/outlet
252 exhaust holding abd-area 254 chamber bbb-outlet
256 exhaust bbc-inlet/outlet 258 exhaust holding bbd-area
260 ahc-exhaust pipe 262 exhaust ahd-outlet
264 bhc-exhaust pipe 266 exhaust bhd-outlet

### DETAILED DESCRIPTION OF THE INVENTION

### Flywheel Vane Combustion Engine 110

Said flywheel vane combustion engine 110 converts energy into mechanical force. Said yyy-flywheel 240 being enclosed within said flywheel vane combustion engine 110. Said www-cylinder 112 housing said combustion aba-chamber 118 and said combustion bba-chamber 128. Said www-cylinder 112 being closed at both ends, with said combustion aba-chamber 118 at one end and said combustion bba-chamber 128 at the other end. Said flywheel vane combustion engine 110 having said www-cylinder 112 mounted near said yyy-flywheel 240.

Said xxx-piston 138 lying within said www-cylinder 112. Said www-cylinder 112 having a chamber abb-outlet 248 and a chamber bbb-outlet 254 along with a ahc-exhaust pipe 260 and a bhc-exhaust pipe 264. Said xxx-piston 138 having said exhaust holding abd-area 252 with a exhaust abc-inlet/outlet 250 also having said exhaust holding bbd-area 258 with a exhaust bbc-inlet/outlet 256. Said exhaust holding abd-area 252 at one end of said xxx-piston 138 and said exhaust holding bbd-area 258 at the other end. Said www-cylinder 112 having a cylinder aaa-opening 114 for said piston aka-rod 148 at one side of said www-cylinder 112 and having a cylinder baa-opening 116 on the other side of said www-cylinder 112 for said piston bka-rod 154. Said ahc-exhaust pipe pipe 260 having a exhaust afa-inlet 126 at one end and a exhaust ahd-outlet 262 at the end. Said bhc-exhaust pipe 264 having a exhaust bfa-inlet 136 at one end and a exhaust bhd-outlet 266 at the end.

Said piston aka-rod 148 attached to one side of said xxx-piston 138 along with said piston bka-rod 154 attached to the other side of said xxx-piston 138. Said piston aka-rod 148 attached to said xxx-piston 138 at one end and said air ara-piston 172 at the other end. Said piston bka-rod 154 attached to said xxx-piston 138 at one end and said air bra-piston 178 at the other end.

Said air ara-piston 172 enclosed within said air aoa-cylinder 160. Said air bra-piston 178 enclosed within said air boa-cylinder 166. Said air aoa-cylinder 160 having attached to said air aua-outline 184 and also attached to said air cba-inline 212. Said air boa-cylinder 166 having attached to said air bua-outline 198 and also attached to said air dba-inline 226.

Said air aua-outline 184 having a air outline ava-inlet 186 and also having said air outline awa-outlet 188. Said air cba-inline 212 having said air inline cca-inlet 214 and also having a air inline cda-outlet 216. Said air bua-outline 198 having a air outline bva-inlet 200 and also having said air outline bwa-outlet 202. Said air dba-inline 226 having said air inline dca-inlet 228 and also having a air inline dda-outlet 230.

Said air outline ava-inlet 186 attached to said air aoa-cylinder 160 at one end and said air outline awa-outlet 188 that mounted at periphery of said flywheel eba-vane 244 at the other end. Said air inline cca-inlet 214 that mounted at periphery of said flywheel eba-vane 244 and said air inline cda-outlet 216 attached to said air aoa-cylinder 160 at one end. Said air outline bva-inlet 200 attached to said air boa-cylinder 166 at one end and said air outline bwa-outlet 202 that mounted at periphery of said flywheel eba-vane 244 at the other end. Said air inline dca-inlet 228 that mounted at periphery of said flywheel eba-vane 244 and said air inline dda-outlet 230 attached to said air aoa-cylinder 160 at one end.

Said air aua-outline 184 having a air outline aya-door 192 along with a air outline aza-hinge 194 house within said air aua-outline 184. Said air bua-outline 198 having a air outline bya-door 206 along with a air outline bza-hinge 208 house within said air bua-outline 198. Said air cba-inline 212 having a air inline cfa-door 220 along with a air inline cga-hinge 222 house within said air cba-inline 212. Said air dba-inline 226 having a air inline dfa-door 234 along with a air inline dga-hinge 236 house within said air dba-inline 226.

Said yyy-flywheel 240 at said outer flywheel eaa-edge 242 being attached said flywheel eba-vane 244. Said yyy-flywheel 240 having said drive eca-shaft 246 at the center of said yyy-flywheel 240. Said flywheel eba-vane 244 lying at the at periphery of said air outline awa-outlet 188, said air inline cca-inlet 214, said air outline bwa-outlet 202 and said air inline dca-inlet 228.

Said combustion aba-chamber 118 has a aca-sensor 120, a ada-injector 122, a spark aea-plug 124, said chamber abb-outlet 248. Said aca-sensor 120 measuring to determine the fuel pumping through said ada-injector 122. Said ada-injector 122 admitting air-fuel inside. Said spark aea-plug 124 delivering a spark igniting the mix within said combustion aba-chamber 118.

Said combustion bba-chamber 128 has, a bca-sensor 130, a bda-injector 132, a spark bea-plug 134, said chamber bbb-outlet 254. Said bca-sensor 130 measuring to determine the fuel pumping through said bda-injector 132. Said bda-injector 132 admitting air-fuel inside. Said spark bea-plug 134 delivering a spark igniting the mix within said combustion bba-chamber 128.

A piston aga-ring 140 is fitting around said xxx-piston 138, therefore stopping combustion gases movement from leaving said combustion aba-chamber 118. A piston bga-ring 142 is fitting around said xxx-piston 138, therefore stopping combustion gases movement from leaving said combustion bba-chamber 128. A air piston asa-ring 174 is fitting around said air ara-piston 172, therefore stopping air movement from leaving said air aoa-cylinder 160. A air piston bsa-ring 180 is fitting around said air bra-piston 178, therefore stopping air movement from leaving said air boa-cylinder 166.

Said air aua-outline 184 having said air outline aya-door 192 as open letting the air flow within said air aua-outline 184 and as close stopping air flow within said air aua-outline 184. Said air cba-inline 212 having said air inline cfa-door 220 as open letting the air flow within said air cba-inline 212 and as close stopping air flow within said air cba-inline 212. Said air bua-outline 198 having said air outline bya-door 206 as open letting the air flow within said air bua-outline 198 and as close stopping air flow within said air bua-outline 198.

Said air dba-inline 226 having said air inline dfa-door 234 as open letting the air flow within said air dba-inline 226 and as close stopping air flow within said air dba-inline 226.

Said air outline aza-hinge 194 is used for attaching said air outline aya-door 192 onto said air aua-outline 184. Said air outline bza-hinge 208 is used for attaching said air outline bya-door 206 onto said air bua-outline 198. Said air inline cga-hinge 222 is used for attaching said air inline cfa-door 220 onto said air cba-inline 212. Said air inline dga-hinge 236 is used for attaching said air inline dfa-door 234 onto said air dba-inline 226.

### Movement of Flywheel Vane Combustion Engine 110

The present description provides for said flywheel vane combustion engine 110 mounted near said www-cylinder 112 and enclosed within said flywheel vane combustion engine 110. Enclosed within said flywheel vane combustion engine 110 utilizing member including said www-cylinder 112, used for the fore and aft movement of said xxx-piston 138. Said xxx-piston 138 move fore and aft, within said www-cylinder 112 from said combustion aba-chamber 118 to said combustion bba-chamber 128.

Said combustion aba-chamber 118 used for exploding combustion gases, moving said xxx-piston 138. Said piston aia-head 144 of said xxx-piston 138, pushed by the exploding combustion gases within said combustion aba-chamber 118 moves toward said combustion bba-chamber 128.

Said combustion bba-chamber 128 used for exploding combustion gases, moving said xxx-piston 138. Said piston bia-head 146 of said xxx-piston 138, pushed by the exploding combustion gases within said combustion bba-chamber 128 moves toward said combustion aba-chamber 118.

Said exhaust holding area 252 and said exhaust holding bbd-area 258 is an area within said xxx-piston 138 that would be holding the exhaust before expelling said exhaust.

Exhaust that was left within said combustion aba-chamber 118 or said combustion bba-chamber 128 that did not expel into said exhaust holding area 252 or said exhaust holding bbd-area 258 would help said xxx-piston 138 to hold and keep pressure on the air/fuel before air/fuel explodes within said combustion aba-chamber 118 or said combustion bba-chamber 128.

Said xxx-piston 138 would have said exhaust holding abd-area 252 near one end and said exhaust holding bbd-area 258 near the other end. Said exploding of combustion gases within said combustion aba-chambers 118 or said combustion bba-chamber 128 with said xxx-piston 138 would move fore and aft from said combustion aba-chamber 118 and said combustion bba-chamber 128 within said www-cylinder 112. Said exploding of combustion gases would turn into exhaust gases. On the movement of said xxx-piston 138, said exhaust gases would be expel into said exhaust holding abd-area 252 or expel into said exhaust holding bbd-area 258.

As said xxx-piston 138 move toward said combustion bba-chamber 128, said chamber abb-outlet 248 would open up letting some of the exhaust gases of said combustion aba-chamber 118 expel into said exhaust holding abd-area 252. Some of exhaust gases would not be expel and stay within said combustion aba-chamber 118, as this exhaust gases pressure would hold the pressure within said combustion-bba-chamber 128. Therefore keeping pressure on and holding pressure on said xxx-piston 138 before air/fuel explodes within said combustion bba-chamber 128. As-said xxx-piston 138 move toward said combustion bba-chamber 128, said chamber abb-outlet 248 would open up letting out some of its exhaust gases, expelling these gases into said exhaust holding abd-area 252. Than said chamber abb-outlet 248 would close-up stopping any said exhaust from entering back into said combustion aba-chamber 118, than said exhaust afa-inlet 126 would-open up letting said exhaust eipel out into the atmosphere. As said xxx-piston 138 move toward said combustion bba-chamber 128 said chamber bbb-outlet 254 would open up expelling some of its exhaust gases into said exhaust holding bbd-area 258. Than said chamber bbb-outlet 254 would close up and said said bda-injector 132 would open up expelling air/fuel within said combustion bba-chamber 128. With said xxx-piston 138 movement toward said combustion bba-chamber 128 the pressure is being put on said air/fuel within said combustion bba-chamber 128. Said spark bea-plug 134 would spark exploding said air/fuel.

As said xxx-piston 138 move toward said combustion aba-chamber 118, said chamber bbb-outlet 254 would open up letting some of the exhaust gases of said combustion bba-chamber 128 expel into said exhaust holding bbd-area 258. Some of exhaust gases would not be expel and stay within said combustion bba-chamber 128, as this exhaust gases pressure would hold the pressure within said combustion aba-chamber 118. Therefore keeping pressure on and holding pressure on said xxx-piston 138 before air/fuel explodes within said combustion aba-chamber 118. As said xxx-piston 138 move toward said combustion aba-chamber 118, said chamber bbb-outlet 254 would open up letting out some of its exhaust gases, expelling these gases into said exhaust holding bbd-area 258. Than said chamber bbb-outlet 254 would close up stopping any said exhaust from entering back into said combustion bba-chamber 128, than said exhaust bfa-inlet 136 would open up letting said exhaust expel out into the atmosphere. As said xxx-piston 138 move toward said combustion aba-chamber 118 said chamber abb-outlet 248 would open up expelling some of its exhaust gases into said exhaust holding abd-area 252. Than said chamber abb-outlet 248 would close up and said said ada-injector 122 would open up expelling air/fuel within said combustion aba-chamber 118. With said xxx-piston 138 movement toward said combustion aba-chamber 118 the pressure is being put on said air/fuel within said combustion aba-chamber 118. Said spark aea-plug 124 would spark exploding said air/fuel.

Said xxx-piston 138 used for the movement of said piston aka-rod 148. Said piston aka-rod 148 attached to said xxx-piston 138 at one end and with said air ara-piston 172 at the other end, this would result in the fore and aft movement of said air ara-piston 172.

Said xxx-piston 138 used for the movement of said piston bka-rod 154. Said piston bka-rod 154 attached to said xxx-piston 138 at one end and with said air bra-piston 178 at the other end, this would result in the fore and aft movement of said air bra-piston 178.

Said piston aka-rod 148 used for the movement of said air ara-piston 172 to move fore and aft within the movement of said xxx-piston 138.

Said piston bka-rod 154 used for the movement of said air bra-piston 178 to move fore and aft within the movement of said xxx-piston 138.

Said air aoa-cylinder 160 used for the fore and aft movement of said air ara-piston 172. Said air cylinder apa-chamber 162 within said air aoa-cylinder 160 is a air piston ata-head 176 of said air ara-piston 172.

Said air boa-cylinder 166, used for the fore and aft movement of said air bra-piston 178. Said air cylinder bpa-chamber 168 within said air boa-cylinder 166 is a air piston bta-head 182 of said air bra-piston 178.

Said air ara-piston 172 used for moving air outward out of said air aoa-cylinder 160 or drawing air into said air aoa-cylinder 160.

Said air bra-piston 178 used for moving air outward out of said air cylinder apa-chamber 162 or drawing air into said air cylinder apa-chamber 162.

Said air aua-outline 184 used for movement of air from said air cylinder apa-chamber 162 outward onto said flywheel eba-vane 244.

Outward movement of said air ara-piston 172 with its outward air pressure would open said air outline aya-door 192 and with its air pressure would close said air inline cfa-door 220.

Said air outline aya-door 192 as open, used for letting movement of air though said air aua-outline 184.

Said air outline aya-door 192 as closed, used for stopping movement of air though said air aua-outline 184.

Said air bua-outline 198 used for movement of air from said air cylinder bpa-chamber 168 outward onto said flywheel eba-vane 244.

Outward movement of said air bra-piston 178 with its outward air pressure would open said air outline bya-door 206 and with its air pressure would close said air inline dfa-door 234.

Said air outline bya-door 206 as open, used for letting movement of air though said air bua-outline 198.

Said air outline bya-door 206 as closed, used for stopping movement of air though said air bua-outline 198.

Said air cba-inline 212 is used for movement of air inward from said flywheel eba-vane 244 that being drawn into said air cylinder apa-chamber 162.

Inward movement of said air ara-piston 172 with its inward air pressure would open said air inline cfa-door 220 and with its air pressure would close said air outline aya-door 192.

Said air inline cfa-door 220 as open, used for letting movement of air though said air cba-inline 212.

Said air inline cfa-door 220 as closed, used for stopping movement of air though said air cba-inline 212.

Said air dba-inline 226 is used for movement of air inward from said flywheel eba-vane 244 that being drawn into said air cylinder bpa-chamber 168. Inward movement of said air ara-piston 172 with its inward air pressure would open said air inline dfa-door 234 and with its air pressure would close said air outline bya-door 206.

Said air inline dfa-door 234 as open, used for letting movement of air though said air dba-inline 226.

Said air inline dfa-door 234 as closed, used for stopping movement of air though said air dba-inline 226.

Said yyy-flywheel 240, used to attached said flywheel eba-vane 244 onto. Said flywheel eba-vane 244 used for the compressed air to push and pull said yyy-flywheel 240 in a rotary motion. The pushing of said air onto said flywheel eba-vane 244 at one place and then drawing said air off after that place on said flywheel eba-vane 244 this would move said yyy-flywheel 240 in a rotary motion. Said yyy-flywheel 240 attached to said drive eca-shaft 246 that would be rotating said drive eca-shaft 246.

Said drive eca-shaft 246, attached to said yyy-flywheel 240, used for converting energy into mechanical energy or work. www-cylinder 112

Enclosed within said flywheel vane combustion engine 110 said www-cylinder 112. Said www-cylinder 112 utilizing member including said cylinder aaa-opening 114 and said cylinder baa-opening 116, said exhaust afa-inlet 126, said exhaust bfa-inlet 136. Said www-cylinder 112 housing said combustion aba-chamber 118 and said combustion bba-chamber 128 along with said xxx-piston 138. Said www-cylinder 112 closed at both ends, with said combustion aba-chamber 118 and said combustion bba-chamber 128 house within. Said www-cylinder 112 having said chamber abb-outlet 248 and said chamber bbb-outlet 254. Said xxx-piston 138 having said exhaust holding abd-area 252 with said exhaust abc-inlet/outlet 250 also having said exhaust holding bbd-area 258 with said exhaust bbc-inlet/outlet 256. Said exhaust holding abd-area 252 at one end of said xxx-piston 138 and said exhaust holding bbd-area 258 at the other end. Said www-cylinder 112 having said cylinder aaa-opening 114 for movement of said piston aka-rod 148 at one side of said www-cylinder 112 and having said cylinder baa-opening 116 on the other side of said www-cylinder 112 for movement of said piston bka-rod 154.

Said piston aka-rod 148 attached to one side of said xxx-piston 138 along with said piston bka-rod 154 attached to the other side of said xxx-piston 138. Said piston aka-rod 148 attached to said xxx-piston 138 at a rod ama-point 150. Said piston bka-rod 154 attached to said xxx-piston 138 at a rod bma-point 156.

Said www-cylinder 112 used for the fore and aft movement of said xxx-piston 138 from said combustion aba-chamber 118 and said combustion bba-chamber 128. Said xxx-piston 138 axially slid ably mounted therein to reciprocate between said combustion aba-chamber 118 and said combustion bba-chamber 128.

Said combustion aba-chamber 118 housing said aca-sensor 120, said ada-injector 122 and said spark aea-plug 124 along with said chamber abb-outlet 248. Said aca-sensor 120 used for measuring the inwardness of said xxx-piston 138 to determine the point for fuel pumping through said ada-injector 122. Said ada-injector 122 used for fuel pumping into said combustion aba-chamber 118. Said spark aea-plug 124 used for delivering a spark igniting the mix within said combustion aba-chamber 118.

Said combustion bba-chamber 128 housing said bca-sensor 130, said bda-injector 132 and said spark bea-plug 134 along with said exhaust bbc-inlet/outlet 256. Said bca-sensor 130 used for measuring the inwardness of said xxx-piston 138 to determine the point for fuel pumping through said bda-injector 132. Said bda-injector 132 used for fuel pumping into said combustion bba-chamber 128. Said spark bea-plug 134 used for delivering a spark igniting the mix within said combustion bba-chamber 128.

Said chamber abb-outlet 248 used for exhaust to leave said combustion aba-chamber 118 as this exhaust would enter said exhaust abc-inlet/outlet 250 entering into said exhaust holding abd-area 252. Exhaust that enter said exhaust holding abd-area 252 would leave said exhaust holding abd-area 252 and enter said exhaust afa-inlet 126 and leave said flywheel vane combustion engine 110.

Said chamber bbb-outlet 254 used for exhaust to leave said combustion bba-chamber 128 as this exhaust would enter said exhaust bbc-inlet/outlet 256 entering into said exhaust holding bbd-area 258. Exhaust that enter said exhaust holding bbd-area 258 would leave said exhaust holding bbd-area 258 and enter said exhaust bfa-inlet 136 and leave said flywheel vane combustion engine 110.

Said combustion aba-chamber 118 used for exploding combustion gases that would be moving said xxx-piston 138. The exploding gases inside said combustion aba-chamber 118 resulting in the movement of pushing said xxx-piston 138 toward said combustion bba-chamber 128. Said combustion bba-chamber 128 used for exploding combustion gases moving said xxx-piston 138. The exploding gases inside said combustion bba-chamber 128 resulting in the movement of pushing said xxx-piston 138 toward said combustion aba-chamber 118.

Said exhaust abc-inlet/outlet 250 used for exhaust to leave said combustion aba-chamber 118, exhaust leaving said flywheel vane combustion engine 110. Said exhaust bbc-inlet/outlet 256 used for exhaust to leave said combustion bba-chamber 128, exhaust leaving said flywheel vane combustion engine 110.

Said www-cylinder 112, used for the movement of said xxx-piston 138, to move fore and aft, from said combustion aba-chamber 118 to said combustion bba-chamber 128. Said piston aia-head 144, of said xxx-piston 138, pushed by the exploding combustion gases within said combustion aba-chamber 118, moves toward said combustion bba-chamber 128.

Said piston aga-ring 140, fitting near said combustion aba-chamber 118, around said xxx-piston 138. Said piston aga-ring 140, fitting around said xxx-piston 138, stopping combustion gases movement from leaving said combustion aba-chamber 118, around said xxx-piston 138. Said piston bga-ring 142, fitting near said combustion bba-chamber 128, around said xxx-piston 138. Said piston bga-ring 142, fitting around said xxx-piston 138, stopping combustion gases movement from leaving said combustion bba-chamber 128, around said xxx-piston 138.

Said piston aka-rod 148, attached to said xxx-piston 138. Said rod ama-point 150, attaching said xxx-piston 138, said piston aka-rod 148 together. Said piston aka-rod 148 and said air ara-piston 172, moves within the movement of said xxx-piston 138. Said piston bka-rod 154, attached to said xxx-piston 138. Said rod bma-point 156, attaching said xxx-piston 138, said piston bka-rod 154 together. Said piston bka-rod 154 and said air bra-piston 178, moves within the movement of said xxx-piston 138.

Said www-cylinder 112 has, said cylinder aaa-opening 114. Said cylinder aaa-opening 114, used for movement of said piston aka-rod 148, attached to said xxx-piston 138. Said cylinder aaa-opening 114, opening on one side of said www-cylinder 112, said cylinder baa-opening 116, opening opposite side, of said www-cylinder 112. Said piston aka-rod 148, attached to said xxx-piston 138, and extended though said cylinder aaa-opening 114. Said cylinder aaa-opening 114, used for movement of said piston aka-rod 148, to move fore and aft, within movements of said xxx-piston 138.

Said www-cylinder 112, used for the movement of said xxx-piston 138, to move fore and aft, from said combustion bba-chamber 128 to said combustion aba-chamber 118. Said piston bia-head 146, of said xxx-piston 138, pushed by the exploding combustion gases within said combustion bba-chamber 128, moves toward said combustion aba-chamber 118.

Said www-cylinder 112 has, said cylinder baa-opening 116. Said cylinder baa-opening 116, used for movement of said piston bka-rod 154, attached to said xxx-piston 138. Said cylinder baa-opening 116, opening on one side of said www-cylinder 112, said cylinder aaa-opening 114, opening opposite side, of said www-cylinder 112. Said piston bka-rod 154, attached to said xxx-piston 138, and extended though said cylinder baa-opening 116. Said cylinder baa-opening 116, used for movement of said piston bka-rod 154, to move fore and aft, within movements of said xxx-piston 138.

### Combustion aba-Chamber 118

Enclosed within said www-cylinder 112 said combustion aba-chamber 118. Said combustion aba-chamber 118 utilizing member including said aca-sensor 120, said ada-injector 122, said spark aea-plug 124, said chamber abb-outlet 248.

Said combustion aba-chamber 118 has, said aca-sensor 120, said ada-injector 122, said spark aea-plug 124, said chamber abb-outlet 248. Said combustion aba-chamber 118, house within said www-cylinder 112. Said www-cylinder 112 closed at both ends having said combustion aba-chamber 118 at one end, said combustion bba-chamber 128 at the other end.

Said combustion aba-chamber 118 enclosure in which combustion with a fuel or propellant is initiated and controlled. Said combustion aba-chamber 118, used for exploding combustion gases, moving said xxx-piston 138. The exploding gases inside said combustion aba-chamber 118 resulting in the movement of pushing said xxx-piston 138, toward said combustion bba-chamber 128. Said piston aia-head 144, of said xxx-piston 138, pushed by the exploding combustion gases within said combustion aba-chamber 118, moves toward said combustion bba-chamber 128. The exploding gases inside said combustion bba-chamber 128 resulting in the movement of pushing said xxx-piston 138, toward said combustion aba-chamber 118. Said piston bia-head 146, of said xxx-piston 138, pushed by the exploding combustion gases within said combustion bba-chamber 128, moves toward said combustion aba-chamber 118. Said xxx-piston 138 move fore and aft, from said combustion aba-chamber 118, to said combustion bba-chamber 128.

Said aca-sensor 120, inserted into side of said combustion aba-chamber 118. Said aca-sensor 120, measuring the inwardness of said xxx-piston 138, to determine the point for amount of and fuel pumping through said ada-injector 122.

Said ada-injector 122, inserted into side of said combustion aba-chamber 118. Said ada-injector 122 and the electrical fuel pumping means not shown receives a signal from said aca-sensor 120. Said ada-injector 122, receives a signal from said aca-sensor 120, the point used for amount and fuel pumping through said ada-injector 122. Said ada-injector 122, admitting air-fuel inside said combustion aba-chamber 118.

Said spark aea-plug 124, inserted into side of said combustion aba-chamber 118. Said spark aea-plug 124, receives a signal from said aca-sensor 120. Said spark aea-plug 124, delivering a spark igniting the mix within said combustion aba-chamber 118. Air-fuel inside said combustion aba-chamber 118 explodes.

Said chamber abb-outlet 248, opening in said combustion aba-chamber 118. As said xxx-piston 138 move toward said combustion bba-chamber 128 said chamber abb-outlet 248 would open up letting said exhaust gases of said combustion aba-chamber 118 expel into said exhaust holding abd-area 252. Affer moving over said chamber abb-outlet 248 opening, said xxx-piston 138 moving toward said combustion bba-chamber 128, said chamber abb-outlet 248 would close up stopping any said exhaust from entering back into said combustion aba-chamber 118, than after moving over said exhaust afa-inlet 126 would than open up letting said exhaust expel out into the atmosphere.

### Combustion bba-Chamber 128

Said combustion bba-chamber 128 utilizing member including said bca-sensor 130, said bda-injector 132, said spark bea-plug 134, said chamber bbb-outlet 254.

Said combustion bba-chamber 128 has, said bca-sensor 130, said bda-injector 132, said spark bea-plug 134, said chamber bbb-outlet 254. Said combustion bba-chamber 128, house within said www-cylinder 112. Said www-cylinder 112 closed at both ends having said combustion bba-chamber 128 at one end, said combustion aba-chamber 118 at the other end.

Said combustion bba-chamber 128 enclosure in which combustion with a fuel or propellant is initiated and controlled. Said combustion bba-chamber 128, used for exploding combustion gases, moving said xxx-piston 138. The exploding gases inside said combustion bba-chamber 128 resulting in the movement of pushing said xxx-piston 138, toward said combustion aba-chamber 118. Said piston bia-head 146, of said xxx-piston 138, pushed by the exploding combustion gases within said combustion bba-chamber 128, moves toward said combustion aba-chamber 118. The exploding gases inside said combustion aba-chamber 118 resulting in the movement of pushing said xxx-piston 138, toward said combustion bba-chamber 128. Said piston aia-head 144, of said xxx-piston 138, pushed by the exploding combustion gases within said combustion aba-chamber 118, moves toward said combustion bba-chamber 128. Said xxx-piston 138 move fore and aft, from said combustion bba-chamber 128, to said combustion aba-chamber 118.

Said bca-sensor 130, inserted into side of said combustion bba-chamber 128. Said bca-sensor 130, measuring the inwardness of said xxx-piston 138, to determine the point for amount of and fuel pumping through said bda-injector 132.

Said bda-injector 132, inserted into side of said combustion bba-chamber 128. Said bda-injector 132 and the electrical fuel pumping means not shown receives a signal from said bca-sensor 130. Said bda-injector 132, receives a signal from said bca-sensor 130, the point used for amount and fuel pumping through said bda-injector 132. Said bda-injector 132, admitting air-fuel inside said combustion bba-chamber 128.

Said spark bea-plug 134, inserted into side of said combustion bba-chamber 128. Said spark bea-plug 134, receives a signal from said bca-sensor 130. Said spark bea-plug 134, delivering a spark igniting the mix within said combustion bba-chamber 128. Air-fuel inside said combustion bba-chamber 128 explodes.

Said chamber bbb-outlet 254, opening in said combustion bba-chamber 128. As said xxx-piston 138 move toward said combustion aba-chamber 118 said chamber bbb-outlet 254 would open up letting said exhaust gases of said combustion bba-chamber 128 expel into said exhaust holding bbd-area 258.

Affer moving over said chamber bbb-outlet 254 opening, said xxx-piston 138 moving toward said combustion aba-chamber 118, said chamber bbb-outlet 254 would close up stopping any said exhaust from entering back into said combustion bba-chamber 128, than after moving over said exhaust bfa-inlet 136 would than open up letting said exhaust expel out into the atmosphere.

### xxx-Piston 138

Said xxx-piston 138, utilizing member including, said exhaust holding abd-area 252, with said exhaust abc-inlet/outlet 250, said exhaust holding bbd-area 258, with said exhaust bbc-inlet/outlet 256, said piston aga-ring 140, said piston bga-ring 142, said piston aia-head 144, said piston bia-head 146, said piston aka-rod 148, said piston bka-rod 154.

Said xxx-piston 138, house within said www-cylinder 112. Said xxx-piston 138 move fore and aft, from said combustion aba-chamber 118 to said combustion bba-chamber 128. Said www-cylinder 112 closed at both ends, with said combustion aba-chamber 118 and said combustion bba-chamber 128 house within.

Said xxx-piston 138, used for the movement of said piston bka-rod 154 and said air bra-piston 178, to move fore and aft within the movement of said xxx-piston 138. Said piston bka-rod 154 and said air bra-piston 178, moves within the movement of said xxx-piston 138.

Said exhaust holding area 252 and said exhaust holding bbd-area 258 is an area within said xxx-piston 138 that would be holding the exhaust before expelling said exhaust. Said exhaust that is left within said combustion aba-chamber 118 or said combustion bba-chamber 128, would help said xxx-piston 138 to hold and keep pressure on the air/fuel before air/fuel explodes within said combustion aba-chamber 118 or said combustion bba-chamber 128.

Said xxx-piston 138 has, said piston aga-ring 140, said piston bga-ring 142, said piston aia-head 144, said piston bia-head 146, said piston aka-rod 148, said piston bka-rod 154.

Said piston aga-ring 140, fitting near said piston aia-head 144, around said xxx-piston 138. Said piston aga-ring 140, fitting around said xxx-piston 138, stopping combustion gases movement from leaving said combustion aba-chamber 118, around said xxx-piston 138.

Said piston bga-ring 142, fitting near said piston bia-head 146, around said xxx-piston 138. Said piston bga-ring 142, fitting around said xxx-piston 138, stopping combustion gases movement from leaving said combustion bba-chamber 128, around said xxx-piston 138.

The exploding gases inside said combustion aba-chamber 118 resulting in the movement of pushing said xxx-piston 138, toward said combustion bba-chamber 128. Said piston aia-head 144, of said xxx-piston 138, pushed by the exploding combustion gases within said combustion aba-chamber 118, moves toward said combustion bba-chamber 128. Said xxx-piston 138 move fore and aft, from said combustion aba-chamber 118, to said combustion bba-chamber 128.

The exploding gases inside said combustion bba-chamber 128 resulting in the movement of pushing said xxx-piston 138, toward said combustion aba-chamber 118. Said piston bia-head 146, of said xxx-piston 138, pushed by the exploding combustion gases within said combustion bba-chamber 128, moves toward said combustion aba-chamber 118. Said xxx-piston 138 move fore and aft, from said combustion bba-chamber 128, to said combustion aba-chamber 118.

Said xxx-piston 138, moves said piston aka-rod 148 and said air ara-piston 172, within the movement of said xxx-piston 138.

Said piston aka-rod 148, attached to said xxx-piston 138 at one end, attached to said air ara-piston 172 at the other end.

Said piston aka-rod 148, attached to said xxx-piston 138 at one end, said air ara-piston 172 at the other end, resulting in the fore and aft movement of said air ara-piston 172. Said piston aka-rod 148, attached to said xxx-piston 138, movement though said cylinder aaa-opening 114, opening in said www-cylinder 112.

Said xxx-piston 138, moves said piston bka-rod 154 and said air bra-piston 178, within the movement of said xxx-piston 138.

Said piston bka-rod 154, attached to said xxx-piston 138 at one end, attached to said air bra-piston 178 at the other end.

Said piston bka-rod 154, attached to said xxx-piston 138 at one end, said air bra-piston 178 at the other end, resulting in the fore and aft movement of said air bra-piston 178. Said piston bka-rod 154, attached to said xxx-piston 138, movement though said cylinder baa-opening 116, opening in said www-cylinder 112.

Said xxx-piston 138 attached to, said piston aka-rod 148 attached to, said air ara-piston 172 compressing the outgoing air on the outward stroke, though said air outline ava-inlet 186. Said air ara-piston 172, within said air aoa-cylinder 160, pushes air movement outward into said air outline ava-inlet 186, air movement outward than enters said air aua-outline 184.

Said air ara-piston 172, compressing the incoming air on the inward stroke. Air moves inward though said air cba-inline 212, air moves inward though said air inline cda-outlet 216, drawing the air inward into said air cylinder apa-chamber 162. Said xxx-piston 138 attached to, said piston aka-rod 148 attached to, said air bra-piston 178 compressing the outgoing air on the outward stroke though, said air outline bva-inlet 200. Said air bra-piston 178, within said air boa-cylinder 166, pushes air movement outward into said air outline bva-inlet 200, air movement outward than enters said air bua-outline 198.

Said air bra-piston 178, compressing the incoming air on the inward stroke. Air moves inward though said air dba-inline 226, air moves inward though said air inline dda-outlet 230, drawing the inward air into said air cylinder bpa-chamber 168. ahc-exhaust pipe 260

Said ahc-exhaust pipe 260 utilizing member including said exhaust afa-inlet 126 and said exhaust ahd-outlet 262.

As said xxx-piston 138 move toward said combustion bba-chamber 128, said chamber abb-outlet 248 would open up letting said exhaust gases of said combustion aba-chamber 118 expel into said exhaust holding abd-area 252. Affer moving over said chamber chamber abb-outlet 248 opening, and said xxx-piston 138 moving toward said combustion bba-chamber 128, said chamber abb-outlet 248 would close up stopping any said exhaust from entering back into said combustion aba-chamber 118, than after moving over said exhaust afa-inlet 126 would than open up letting said exhaust expel into said ahc-exhaust pipe 260, than the exhaust would expel into said exhaust ahd-outlet 262, than out into the atmosphere.

### bhc-Exhaust Pipe 264

Said bhc-exhaust pipe 264 utilizing member including said exhaust bfa-inlet 136 and said exhaust bhd-outlet 266.

As said xxx-piston 138 move toward said combustion aba-chamber 118, said chamber bbb-outlet 254 would open up letting said exhaust gases of said combustion bba-chamber 128 expel into said exhaust holding bbd-area 258. Affer moving over said chamber chamber bbb-outlet 254 opening, and said xxx-piston 138 moving toward said combustion aba-chamber 118, said chamber bbb-outlet 254 would close up stopping any said exhaust from entering back into said combustion bba-chamber 128, than after moving over said exhaust bfa-inlet 136 would than open up letting said exhaust expel into said bhc-exhaust pipe 264, than the exhaust would expel into said exhaust bhd-outlet 266, than out into the atmosphere.

### Piston aka-Rod 148

Said piston aka-rod 148, utilizing member including said rod ama-point 150, a rod ana-point 152.

Said piston aka-rod 148 has, said xxx-piston 138, said rod ama-point 150, said air ara-piston 172, said rod ana-point 152.

Said piston aka-rod 148, used for the movement of said air ara-piston 172 to move fore and aft within the movement of said xxx-piston 138. Said piston aka-rod 148 and said air ara-piston 172, moves within the movement of said xxx-piston 138.

Said piston aka-rod 148, attached to said xxx-piston 138 at one end, attached to said air ara-piston 172 at the other end.

Said rod ama-point 150, attaching said xxx-piston 138, said piston aka-rod 148 together. Said rod ana-point 152, attaching said piston aka-rod 148, said air ara-piston 172 together.

Said xxx-piston 138, attached to said piston aka-rod 148, resulting in the fore and aft movement of said piston aka-rod 148. Said piston aka-rod 148, attached to said xxx-piston 138 at one end, said air ara-piston 172 at the other end, resulting in the fore and aft movement of said air ara-piston 172.

Said cylinder aaa-opening 114, opening on one side of said www-cylinder 112, said cylinder baa-opening 116, opening opposite side, of said www-cylinder 112. Said cylinder aaa-opening 114, used for movement of said piston aka-rod 148, to move fore and aft, within movements of said xxx-piston 138. Said piston aka-rod 148, attached to said xxx-piston 138, and extended though said cylinder aaa-opening 114. Said piston aka-rod 148, attached to said xxx-piston 138, movement though said cylinder aaa-opening 114, opening in said www-cylinder 112.

### Piston bka-Rod 154

Said piston bka-rod 154, utilizing member including said rod bma-point 156, a rod bna-point 158.

Said piston bka-rod 154 has, said xxx-piston 138, said rod bma-point 156, said air bra-piston 178, said rod bna-point 158.

Said piston bka-rod 154, used for the movement of said air bra-piston 178 to move fore and aft within the movement of said xxx-piston 138. Said piston bka-rod 154 and said air bra-piston 178, moves within the movement of said xxx-piston 138.

Said piston bka-rod 154, attached to said xxx-piston 138 at one end, attached to said air bra-piston 178 at the other end.

Said rod bma-point 156, attaching said xxx-piston 138, said piston bka-rod 154 together. Said rod bna-point 158, attaching said piston bka-rod 154, said air bra-piston 178 together.

Said xxx-piston 138, attached to said piston bka-rod 154, resulting in the fore and aft movement of said piston bka-rod 154. Said piston bka-rod 154, attached to said xxx-piston 138 at one end, said air bra-piston 178 at the other end, resulting in the fore and aft movement of said air bra-piston 178.

Said cylinder baa-opening 116, opening on one side of said www-cylinder 112, said cylinder aaa-opening 114, opening opposite side, of said www-cylinder 112. Said cylinder baa-opening 116, used for movement of said piston bka-rod 154, to move fore and aft, within movements of said xxx-piston 138. Said piston bka-rod 154, attached to said xxx-piston 138, and extended though said cylinder baa-opening 116. Said piston bka-rod 154, attached to said xxx-piston 138, movement though said cylinder baa-opening 116, opening in said www-cylinder 112.

### Air aoa-Cylinder 160

Said air aoa-cylinder 160, utilizing member including said air cylinder apa-chamber 162, a air cylinder aqa-opening 164. Said air aoa-cylinder 160 housing, said air cylinder apa-chamber 162. Said air aoa-cylinder 160 has, said air cylinder aqa-opening 164, said air outline ava-inlet 186, said air inline cda-outlet 216, said piston aka-rod 148, said air ara-piston 172, said air piston asa-ring 174.

Said air aoa-cylinder 160, used for the fore and aft movement of said air ara-piston 172. Said air cylinder apa-chamber 162, used for fore and aft movement of air by said air ara-piston 172. Said air aoa-cylinder 160, used for outward stroke of said air ara-piston 172, pushing air out of said air cylinder apa-chamber 162, air outward into said air outline ava-inlet 186. Said air aoa-cylinder 160, used for inward stroke of said air ara-piston 172, drawing air in from said air inline cda-outlet 216, air inward into said air cylinder apa-chamber 162.

Said air cylinder aqa-opening 164, opening in said air aoa-cylinder 160. Said air cylinder aqa-opening 164, used for movement of said piston aka-rod 148, attached to said air ara-piston 172.

Said rod ama-point 150, attaching said xxx-piston 138, said piston aka-rod 148 together. Said rod ana-point 152, attaching said piston aka-rod 148, said air ara-piston 172 together. Said piston aka-rod 148, attached to said xxx-piston 138 at one end, attached to said air ara-piston 172 at the other end.

Said xxx-piston 138, attached to said piston aka-rod 148, for said piston aka-rod 148 to move fore and aft in the movement of said xxx-piston 138. Said piston aka-rod 148, attached to said air ara-piston 172, to move fore and aft in the movement of said piston aka-rod 148.

Said air cylinder apa-chamber 162, within said air aoa-cylinder 160. Said air cylinder apa-chamber 162, used for the fore and aft movement of said air ara-piston 172, within said air aoa-cylinder 160. Air movement, resulting from fore and aft movement of said air ara-piston 172.

Said air ara-piston 172, on the outward stroke move toward said flywheel eba-vane 244, attached to said yyy-flywheel 240.

Said air aoa-cylinder 160, air movement outward pushed into said air outline ava-inlet 186, by using said air ara-piston 172, air movement outward than enters said air aua-outline 184.

Said air aua-outline 184 air, as said air ara-piston 172, moves outward toward said yyy-flywheel 240, compressing outgoing air, pushing the air movement outward into said air outline ava-inlet 186, than air outward into said air aua-outline 184, air outward onto said flywheel eba-vane 244.

Said air ara-piston 172 on the inward stroke, move away from said flywheel eba-vane 244, attached to said yyy-flywheel 240. Said air aoa-cylinder 160, draws air movement inward, by using said air ara-piston 172, drawing air inward into said air inline cca-inlet 214, than air inward into said air cba-inline 212, than air inward into said air inline cda-outlet 216, then air inward into said air aoa-cylinder 160.

Said air piston asa-ring 174, fitting around said air ara-piston 172, within said air aoa-cylinder 160. Said air piston asa-ring 174, fitting around said air ara-piston 172, stopping air movement from leaving said air cylinder apa-chamber 162, around said air ara-piston 172.

### Air boa-Cylinder 166

Said air boa-cylinder 166, utilizing member including said air cylinder bpa-chamber 168, a air cylinder bqa-opening 170.

Said air boa-cylinder 166 housing, said air cylinder bpa-chamber 168. Said air boa-cylinder 166 has, said air cylinder bqa-opening 170, said air outline bva-inlet 200, said air inline dda-outlet 230, said piston bka-rod 154, said air bra-piston 178, said air piston bsa-ring 180.

Said air boa-cylinder 166, used for the fore and aft movement of said air bra-piston 178. Said air cylinder bpa-chamber 168, used for fore and aft movement of air by said air bra-piston 178. Said air boa-cylinder 166, used for outward stroke of said air bra-piston 178, pushing air out of said air cylinder bpa-chamber 168, air outward into said air outline bva-inlet 200. Said air boa-cylinder 166, used for inward stroke of said air bra-piston 178, drawing air in from said air inline dda-outlet 230, air inward into said air cylinder bpa-chamber 168.

Said air cylinder bqa-opening 170, opening in said air boa-cylinder 166. Said air cylinder bqa-opening 170, used for movement of said piston bka-rod 154, attached to said air bra-piston 178.

Said rod bma-point 156, attaching said xxx-piston 138, said piston bka-rod 154 together. Said rod bna-point 158, attaching said piston bka-rod 154, said air bra-piston 178 together.

Said piston bka-rod 154, attached to said xxx-piston 138 at one end, attached to said air bra-piston 178 at the other end.

Said xxx-piston 138, attached to said piston bka-rod 154, for said piston bka-rod 154 to move fore and aft in the movement of said xxx-piston 138. Said piston bka-rod 154, attached to said air bra-piston 178, to move fore and aft in the movement of said piston bka-rod 154.

Said air cylinder bpa-chamber 168, within said air boa-cylinder 166. Said air cylinder bpa-chamber 168, used for the fore and aft movement of said air bra-piston 178, within said air boa-cylinder 166. Air movement, resulting from fore and aft movement of said air bra-piston 178.

Said air bra-piston 178, on the outward stroke move toward said flywheel eba-vane 244, attached to said yyy-flywheel 240.

Said air boa-cylinder 166, air movement outward pushed into said air outline bva-inlet 200, by using said air bra-piston 178, air movement outward than enters said air bua-outline 198.

Said air bua-outline 198 air, as said air bra-piston 178, moves outward toward said yyy-flywheel 240, compressing outgoing air, pushing the air movement outward into said air outline bva-inlet 200, than air outward into said air bua-outline 198, air outward onto said flywheel eba-vane 244.

Said air bra-piston 178, on the inward stroke move away from said flywheel eba-vane 244, attached to said yyy-flywheel 240.

Said air boa-cylinder 166, draws air movement inward, by using said air bra-piston 178, drawing air inward into said air inline dca-inlet 228, than air inward into said air dba-inline 226, than air inward into said air inline dda-outlet 230, then air inward into said air boa-cylinder 166.

Said air piston bsa-ring 180, fitting around said air bra-piston 178, within said air boa-cylinder 166. Said air piston bsa-ring 180, fitting around said air bra-piston 178, stopping air movement from leaving said air cylinder bpa-chamber 168, around said air bra-piston 178.

### Air ara-Piston 172

Said air ara-piston 172, utilizing member including said air piston asa-ring 174, said air piston ata-head 176.

Said air ara-piston 172 has, said piston aka-rod 148, said air piston asa-ring 174, said air piston ata-head 176.

Said air ara-piston 172, used for the movement of air in said air cylinder apa-chamber 162. Said air cylinder apa-chamber 162, used for fore and aft movement of air by said air ara-piston 172.

Said air piston ata-head 176, of said air ara-piston 172, on the outward stroke pushes air within said air cylinder apa-chamber 162, air toward said air outline ava-inlet 186, pushing the air outward into said air outline ava-inlet 186, than air outward into said air aua-outline 184.

Said air piston ata-head 176, of said air ara-piston 172, on the inward stroke drawing air inward into said air cylinder apa-chamber 162, drawing air inward though said air inline cda-outlet 216, air inward coming from said air cba-inline 212.

Said air ara-piston 172 on the outward stroke, within said air aoa-cylinder 160, air pushed from said air cylinder apa-chamber 162, air outward into said air outline ava-inlet 186.

Said air ara-piston 172 on the inward stroke, within said air aoa-cylinder 160, used for movement of air drawn from said air inline c,da-outlet 216, drawing air inward into said air cylinder apa-chamber 162.

Said piston aka-rod 148 moves, said air ara-piston 172 to move fore and aft, within the movements of said xxx-piston 138.

Said rod ama-point 150, attaching said xxx-piston 138, said piston aka-rod 148 together. Said rod ana-point 152, attaching said piston aka-rod 148, said air ara-piston 172 together.

Said air ara-piston 172 move fore and aft, within said air aoa-cylinder 160. Said air ara-piston 172, resulting in the air movement, from fore and aft movement of said air ara-piston 172.

Said air ara-piston 172, moves outward toward said yyy-flywheel 240, compressing outgoing air, pushing the air movement outward into said air outline ava-inlet 186, than air outward into said air aua-outline 184. The compressed air from said air aua-outline 184, air outward than air enters said air outline awa-outlet 188, than air outward onto said flywheel eba-vane 244, rotating said yyy-flywheel 240 in a rotary motion.

Said air ara-piston 172, on the inward stroke move away from said flywheel eba-vane 244, attached to said yyy-flywheel 240.

Said air ara-piston 172, compressing the incoming air on the inward stroke though said air inline cca-inlet 214, air moves inward though said air cba-inline 212, than air moves inward though said air inline cda-outlet 216, drawing the air inward into said air cylinder apa-chamber 162.

Said air piston asa-ring 174, fitting around said air ara-piston 172. Said air piston asa-ring 174, fitting around said air ara-piston 172, stopping air movement from leaving said air aoa-cylinder 160, around said air ara-piston 172.

### Air bra-Piston 178

Said air bra-piston 178, utilizing member including said air piston bsa-ring 180, said air piston bta-head 182.

Said air bra-piston 178 has, said piston bka-rod 154, said air piston bsa-ring 180, said air piston bta-head 182.

Said air bra-piston 178, used for the movement of air in said air cylinder bpa-chamber 168. Said air cylinder bpa-chamber 168, used for fore and aft movement of air by said air bra-piston 178.

Said air piston bta-head 182, of said air bra-piston 178, on the outward stroke pushes air within said air cylinder bpa-chamber 168, air toward said air outline bva-inlet 200, pushing the air outward into said air outline bva-inlet 200, than air outward into said air bua-outline 198.

Said air piston bta-head 182, of said air bra-piston 178, on the inward stroke drawing air inward into said air cylinder bpa-chamber 168, drawing air inward though said air inline dda-outlet 230, air inward coming from said air dba-inline 226.

Said air bra-piston 178 on the outward stroke, within said air boa-cylinder 166, air pushed from said air cylinder bpa-chamber 168, air outward into said air outline bva-inlet 200.

Said air bra-piston 178 on the inward stroke, within said air boa-cylinder 166, used for movement of air drawn from said air inline dda-outlet 230, drawing air inward into said air cylinder bpa-chamber 168.

Said piston bka-rod 154 moves, said air bra-piston 178 to move fore and aft, within the movements of said xxx-piston 138.

Said rod bma-point 156, attaching said xxx-piston 138, said piston bka-rod 154 together. Said rod bna-point 158, attaching said piston bka-rod 154, said air bra-piston 178 together. Said air bra-piston 178 move fore and aft, within said air boa-cylinder 166. Said air bra-piston 178, resulting in the air movement, from fore and aft movement of said air bra-piston 178.

Said air bra-piston 178, moves outward toward said yyy-flywheel 240, compressing outgoing air, pushing the air movement outward into said air outline bva-inlet 200, than air outward into said air bua-outline 198. The compressed air from said air bua-outline 198, air outward than air enters said air outline bwa-outlet 202, than air outward onto said flywheel eba-vane 244, rotating said yyy-flywheel 240 in a rotary motion.

Said air bra-piston 178, on the inward stroke move away from said flywheel eba-vane 244, attached to said yyy-flywheel 240.

Said air bra-piston 178, compressing the incoming air on the inward stroke though said air inline dca-inlet 228, air moves inward though said air dba-inline 226, than air moves inward though said air inline dda-outlet 230, drawing the air inward into said air cylinder bpa-chamber 168.

Said air piston bsa-ring 180, fitting around said air bra-piston 178. Said air piston bsa-ring 180, fitting around said air bra-piston 178, stopping air movement from leaving said air boa-cylinder 166, around said air bra-piston 178.

### Air aua-Outline 184

Said air aua-outline 184, utilizing member including said air outline ava-inlet 186, said air outline awa-outlet 188, a air outline axa-chamber 190, said air outline aya-door 192, said air outline aza-hinge 194, a air outline door caa-vane 196.

Said air aua-outline 184 housing, said air outline axa-chamber 190, said air outline aya-door 192, said air outline aza-hinge 194, said air outline door caa-vane 196. Said air aua-outline 184 has, said air outline ava-inlet 186, said air outline awa-outlet 188.

Said air aua-outline 184, being a pipe used for conveying the air from said air cylinder apa-chamber 162, air outward onto said flywheel eba-vane 244. Said air aua-outline 184, used for movement of air from said air cylinder apa-chamber 162, air outward onto said flywheel eba-vane 244. Said air ara-piston 172 on the outward stroke, air within said air cylinder apa-chamber 162, air pushed outward into said air outline ava-inlet 186, than air pushed outward into said air aua-outline 184. Air from said air aua-outline 184, air is pushed outward into said air outline awa-outlet 188, than air outward onto said flywheel eba-vane 244, rotating said yyy-flywheel 240 in a rotary motion. Air coming onto said flywheel eba-vane 244 from said air outline awa-outlet 188, would be pushed outward onto said flywheel eba-vane 244, before air that would be drawn into said air inline cca-inlet 214 off said flywheel eba-vane 244. This way said air pushed onto said flywheel eba-vane 244 would push said flywheel eba-vane 244 forward and said air that being drawn off said flywheel eba-vane 244 would pull said flywheel eba-vane 244 forward in a rotary motion.

Said air aua-outline 184 air movement outward, passes though onto said flywheel eba-vane 244, air from said air aoa-cylinder 160. Said air ara-piston 172, compressing the outgoing air on the outward stroke though said air outline ava-inlet 186. Air movement outward of the compressed air from said air aoa-cylinder 160, outward air enters said air outline ava-inlet 186, than air outward enters said air aua-outline 184. Outward air movement from said air aua-outline 184, air outward enters said air outline awa-outlet 188, then air outward onto said flywheel eba-vane 244.

Said air outline axa-chamber 190, a open area within said air aua-outline 184. Said air outline axa-chamber 190, a open area used for opening and closing, said air outline aya-door 192.

Said air outline aza-hinge 194, used for attaching said air outline aya-door 192, onto said air aua-outline 184. Said air outline aza-hinge 194, used for opening and closing said air outline aya-door 192.

Said air outline aya-door 192 as closed, used for stopping air movement in said air aua-outline 184. Said air outline aya-door 192 as closed, stopping air from entering said air aua-outline 184.

Said air outline aya-door 192 as open, used for letting air movement though said air aua-outline 184. Said air outline aya-door 192 as open, letting air movement to enter said air aua-outline 184. Said air outline aya-door 192 as open, letting air movement to leave said air aua-outline 184, air outward onto said flywheel eba-vane 244.

Said air outline aza-hinge 194, attached to end of said air outline aya-door 192 and attached to said air aua-outline 184, for open and closing said air outline aya-door 192. Said air outline door caa-vane 196, used for air movement inward moving onto and closing said air outline aya-door 192. Said air outline aza-hinge 194, attached to end of said air outline aya-door 192. Said air outline caa-hinge 196, used for air movement inward moving onto and closing said air outline aya-door 192.

### Air Outline aya-Door 192

Said air outline aya-door 192, utilizing member including said air outline aza-hinge 194, said air outline door caa-vane 196. Said air outline aya-door 192 has, said air outline aza-hinge 194, said air outline door caa-vane 196.

Said air outline axa-chamber 190, said air outline aya-door 192, said air outline aza-hinge 194, said air outline door caa-vane 196, house within said air aua-outline 184.

Said air outline aya-door 192 as open, used for letting movement of air though said air aua-outline 184, air outward onto said flywheel eba-vane 244, air from said air cylinder apa-chamber 162. Said air outline aya-door 192 as closed, used for stopping movement of air though said air aua-outline 184.

Said air outline axa-chamber 190, a open area within said air aua-outline 184. Said air outline axa-chamber 190, a open area used for opening and closing, said air outline aya-door 192. Said air aua-outline 184 air movement outward, passes though onto said flywheel eba-vane 244, air from said air aoa-cylinder 160.

Said air outline aya-door 192 as closed, used for stopping air movement in said air aua-outline 184. Said air outline aya-door 192 as closed, stopping air from entering said air aua-outline 184.

Said air outline aya-door 192 as open, used for letting air movement though said air aua-outline 184. Said air outline aya-door 192 as open, letting air movement to enter said air aua-outline 184. Said air outline aya-door 192 as open, letting air movement to leave said air aua-outline 184, air movement outward onto said flywheel eba-vane 244.

Said air ara-piston 172 on the outward stroke, air from said air cylinder apa-chamber 162, air pushed outward into said air outline ava-inlet 186, air outward into said air aua-outline 184, than air outward onto said air outline aya-door 192, pushing said air outline aya-door 192 open.

Said air outline door caa-vane 196, attached to end of said air outline aya-door 192. Said air ara-piston 172 on the inward stroke, air drawn off said flywheel eba-vane 244, air drawn into said air outline awa-outlet 188, than air drawn inward into said air aua-outline 184, drawing air inward onto said air outline door caa-vane 196, pulling on and closing said air outline aya-door 192.

Said air outline aza-hinge 194, used for attaching said air outline aya-door 192, onto said air aua-outline 184. Said air outline aza-hinge 194, used for opening and closing said air outline aya-door 192.

### Air bua-Outline 198

Said air bua-outline 198, utilizing member including said air outline bva-inlet 200, said air outline bwa-outlet 202, a air outline bxa-chamber 204, said air outline bya-door 206, said air outline bza-hinge 208, a air outline door daa-vane 210.

Said air bua-outline 198 housing, said air outline bxa-chamber 204, said air outline bya-door 206, said air outline bza-hinge 208, said air outline door daa-vane 210. Said air bua-outline 198 has, said air outline bva-inlet 200, said air outline bwa-outlet 202.

Said air bua-outline 198, being a pipe used for conveying the air from said air cylinder bpa-chamber 168, air outward onto said flywheel eba-vane 244. Said air bua-outline 198, used for movement of air from said air cylinder bpa-chamber 168, air outward onto said flywheel eba-vane 244. Said air bra-piston 178 on the outward stroke, air within said air cylinder bpa-chamber 168, air pushed outward into said air outline bva-inlet 200, than air pushed outward into said air bua-outline 198. Air from said air bua-outline 198, air is pushed outward into said air outline bwa-outlet 202, than air outward onto said flywheel eba-vane 244, rotating said yyy-flywheel 240 in a rotary motion. Air coming onto said flywheel eba-vane 244 from said air outline bwa-outlet 202, would be pushed outward onto said flywheel eba-vane 244, before air that would be drawn into said air inline dca-inlet 228 off said flywheel eba-vane 244. This way said air pushed onto said flywheel eba-vane 244 would push said flywheel eba-vane 244 forward and said air that being drawn off said flywheel eba-vane 244 would pull said flywheel eba-vane 244 forward in a rotary motion.

Said air bua-outline 198 air movement outward, passes though onto said flywheel eba-vane 244, air from said air boa-cylinder 166. Said air bra-piston 178, compressing the outgoing air on the outward stroke though said air outline bva-inlet 200. Air movement outward of the compressed air from said air boa-cylinder 166, outward air enters said air outline bva-inlet 200, than air outward enters said air bua-outline 198. Outward air movement from said air bua-outline 198, air outward enters said air outline bwa-outlet 202, then air outward onto said flywheel eba-vane 244.

Said air outline bxa-chamber 204, a open area within said air bua-outline 198. Said air outline bxa-chamber 204, a open area used for opening and closing, said air outline bya-door 206.

Said air outline bza-hinge 208, used for attaching said air outline bya-door 206, onto said air bua-outline 198. Said air outline bza-hinge 208, used for opening and closing said air outline bya-door 206.

Said air outline bya-door 206 as closed, used for stopping air movement in said air bua-outline 198. Said air outline bya-door 206 as closed, stopping air from entering said air bua-outline 198.

Said air outline bya-door 206 as open, used for letting air movement though said air bua-outline 198. Said air outline bya-door 206 as open, letting air movement to enter said air bua-outline 198. Said air outline bya-door 206 as open, letting air movement to leave said air bua-outline 198, air outward onto said flywheel eba-vane 244.

Said air outline door daa-vane 210, attached to end of said air outline bya-door 206. Said air outline door daa-vane 210, used for air movement inward moving onto and closing said air outline bya-door 206.

### Air Outline bya-Door 206

Said air outline bya-door 206, utilizing member including said air outline bza-hinge 208, said air outline door daa-vane 210. Said air outline bya-door 206 has, said air outline bza-hinge 208, said air outline door daa-vane 210.

Said air outline bxa-chamber 204, said air outline bya-door 206, said air outline bza-hinge 208, said air outline door daa-vane 210, house within said air bua-outline 198.

Said air outline-bya-door 206 as open, used for letting movement of air though said air bua-outline 198, air outward onto said flywheel eba-vane 244, air from said air cylinder bpa-chamber 168. Said air outline bya-door 206 as closed, used for stopping movement of air though said air bua-outline 198.

Said air outline bxa-chamber 204, a open area within said air bua-outline 198. Said air outline bxa-chamber 204, a open area used for opening and closing, said air outline bya-door 206. Said air bua-outline 198 air movement outward, passes though onto said flywheel eba-vane 244, air from said air boa-cylinder 166.

Said air outline bya-door 206 as closed, used for stopping air movement in said air bua-outline 198. Said air outline bya-door 206 as closed, stopping air from entering said air bua-outline 198.

Said air outline bya-door 206, used for letting air movement though said air bua-outline 198 as open. Said air outline bya-door 206 as open, letting air movement to enter said air bua-outline 198. Said air outline bya-door 206 as open, letting air movement to leave said air bua-outline 198, air movement outward onto said flywheel eba-vane 244.

Said air bra-piston 178 on the outward stroke, air from said air cylinder bpa-chamber 168, air outward pushed into said air outline bva-inlet 200, air outward into said air bua-outline 198, than air outward onto said air outline bya-door 206, pushing said air outline bya-door 206 open.

Said air outline door daa-vane 210, attached to end of said air outline bya-door 206. Said air bra-piston 178 on the inward stroke, air drawn off said flywheel eba-vane 244, air drawn into said air outline bwa-outlet 202, than air drawn inward into said air bua-outline 198, drawing air inward into said air outline door daa-vane 210, pulling on and closing said air outline bya-door 206.

Said air outline bza-hinge 208, used for attaching said air outline bya-door 206, onto said air bua-outline 198. Said air outline bza-hinge 208, used for opening and closing said air outline bya-door 206.

### Air cba-Inline 212

Said air cba-inline 212, utilizing member including said air inline cca-inlet 214, said air inline cda-outlet 216, a air inline cea-chamber 218, said air inline cfa-door 220, said air inline cga-hinge 222, a air inline door cha-vane 224.

Said air cba-inline 212 housing, said air inline cea-chamber 218, said air inline cga-hinge 222, said air inline cfa-door 220, said air inline door cha-vane 224. Said air cba-inline 212 has, said air inline cca-inlet 214, said air inline cda-outlet 216.

Said air cba-inline 212, being a pipe used for conveying the air from said flywheel eba-vane 244, air inward into said air cylinder apa-chamber 162. Said air cba-inline 212, used for movement of air from said flywheel eba-vane 244, air inward into said air cylinder apa-chamber 162. Said air ara-piston 172 on the inward stroke, air drawn off said flywheel eba-vane 244, than air drawn into said air inline cca-inlet 214, than air drawn into said air cba-inline 212. Air from said air cba-inline 212, air drawn into said air inline cda-outlet 216, than air drawn into said air cylinder apa-chamber 162.

Said air cba-inline 212 air movement inward, passes from said flywheel eba-vane 244, air inward into said air aoa-cylinder 160. Said air ara-piston 172, compressing the incoming air on the inward stroke though said air inline cca-inlet 214, air moves inward though said air cba-inline 212, air moves inward though said air inline cda-outlet 216, drawing the air inward into said air cylinder apa-chamber 162. Inward air movement from said flywheel eba-vane 244, air movement inward being compressed enters said air inline cca-inlet 214. Inward air movement from said air cba-inline 212, than air drawn into said air inline cda-outlet 216, then air drawn into said air aoa-cylinder 160. Inward air movement of the compressed air drawn and pulls said yyy-flywheel 240 in a rotary motion. Air coming onto said flywheel eba-vane 244 from said air outline awa-outlet 188, would be pushed outward onto said flywheel eba-vane 244, before air that would be drawn into said air inline cca-inlet 214 off said flywheel eba-vane 244. This way said air pushed onto said flywheel eba-vane 244 would push said flywheel eba-vane 244 forward and said air that being drawn off said flywheel eba-vane 244 would pull said flywheel eba-vane 244 forward in a rotary motion.

Said air inline cea-chamber 218, a open area used for opening and closing, said air inline cfa-door 220.

Said air inline cga-hinge 222, used for attaching said air inline cfa-door 220, onto said air cba-inline 212. Said air inline cga-hinge 222, used for opening and closing said air inline cfa-door 220.

Said air inline cfa-door 220 as closed, used for stopping air movement in said air cba-inline 212. Said air inline cfa-door 220 as closed, stopping air from entering said air cba-inline 212.

Said air inline cfa-door 220 as open, used for letting air movement though said air cba-inline 212. Said air inline cfa-door 220 as open, letting air movement to enter said air cba-inline 212. Said air inline cfa-door 220 as open, letting air movement to leave said air cba-inline 212, air inward into said air aoa-cylinder 160.

Said air inline door cha-vane 224, attached to end of said air inline cfa-door 220. Said air inline door cha-vane 224, used for air movement outward moving onto and closing said air inline cfa-door 220.

### Air Inline cfa-Door 220

Said air inline cfa-door 220, utilizing member including said air inline cga-hinge 222, said air inline door cha-vane 224.

Said air inline cfa-door 220 has, said air inline cga-hinge 222, said air inline door cha-vane 224.

Said air inline cea-chamber 218, said air inline cfa-door 220, said air inline cga-hinge 222, said air inline door cha-vane 224, house within said air cba-inline 212.

Said air inline cea-chamber 218, a open area within said air cba-inline 212. Said air inline cea-chamber 218, a open area used for opening and closing, said air inline cfa-door 220. Said air cba-inline 212 air movement inward, passes though from said flywheel eba-vane 244, air inward into said air cylinder apa-chamber 162.

Said air inline cfa-door 220 as closed, used for stopping air movement in said air cba-inline 212. Said air inline cfa-door 220 as closed, stopping air from entering said air cba-inline 212.

Said air inline cfa-door 220 as open, used for letting air movement though said air cba-inline 212. Said air inline cfa-door 220 as open, letting air movement to enter said air cba-inline 212. Said air inline cfa-door 220 as open, letting air movement to leave said air cba-inline 212, air movement onto said flywheel eba-vane 244.

Said air ara-piston 172 on the inward stroke, air drawn into said air cylinder apa-chamber 162, air drawn from said air inline cda-outlet 216, air draw from said air cba-inline 212, air pulling and drawing said air inline cfa-door 220 open.

Said air inline door cha-vane 224, attached to end of said air inline cfa-door 220. Said air ara-piston 172 on the outward stroke, air drawn into said air inline cda-outlet 216, air drawn into said air cba-inline 212, than air drawn onto said air inline door cha-vane 224, drawing on and closing said air inline cfa-door 220.

Said air inline cga-hinge 222, used for attaching said air inline cfa-door 220, onto said air cba-inline 212. Said air inline cga-hinge 222, used for opening and closing said air inline cfa-door 220.

### Air dba-Inline 226

Said air dba-inline 226, utilizing member including said air inline dca-inlet 228, said air inline dda-outlet 230, a air inline dea-chamber 232, said air inline dfa-door 234, said air inline dga-hinge 236, a air inline door dha-vane 238.

Said air dba-inline 226 housing, said air inline dea-chamber 232, said air inline dga-hinge 236, said air inline dfa-door 234, said air inline door dha-vane 238. Said air dba-inline 226 has, said air inline dca-inlet 228, said air inline dda-outlet 230.

Said air dba-inline 226, being a pipe used for conveying the air from said flywheel eba-vane 244, air inward into said air cylinder bpa-chamber 168. Said air dba-inline 226, used for movement of air from said flywheel eba-vane 244, air inward into said air cylinder bpa-chamber 168. Said air bra-piston 178 on the inward stroke, air drawn off said flywheel eba-vane 244, than air drawn into said air inline dca-inlet 228, than air drawn into said air dba-inline 226. Air from said air dba-inline 226, air drawn into said air inline dda-outlet 230, than air drawn into said air cylinder bpa-chamber 168.

Said air dba-inline 226 air movement inward, passes from said flywheel eba-vane 244, air inward into said air boa-cylinder 166. Said air bra-piston 178, compressing the incoming air on the inward stroke though said air inline dca-inlet 228, air moves inward though said air dba-inline 226, air moves inward though said air inline dda-outlet 230, drawing the air inward into said air cylinder bpa-chamber 168. Inward air movement from said flywheel eba-vane 244, air movement inward being compressed enters said air inline dca-inlet 228. Inward air movement from said air dba-inline 226, than air drawn into said air inline dda-outlet 230, then air drawn into said air boa-cylinder 166. Inward air movement of the compressed air drawn and pulls said yyy-flywheel 240 in a rotary motion. Air coming onto said flywheel eba-vane 244 from said air outline bwa-outlet 202, would be pushed outward onto said flywheel eba-vane 244, before air that would be drawn into said air inline dca-inlet 228 off said flywheel eba-vane 244. This way said air pushed onto said flywheel eba-vane 244 would push said flywheel eba-vane 244 forward and said air that being drawn off said flywheel eba-vane 244 would pull said flywheel eba-vane 244 forward in a rotary motion.

Said air inline dea-chamber 232, a open area used for opening and closing, said air inline dfa-door 234.

Said air inline dga-hinge 236, used for attaching said air inline dfa-door 234, onto said air dba-inline 226. Said air inline dga-hinge 236, used for opening and closing said air inline dfa-door 234.

Said air inline dfa-door 234 as closed, used for stopping air movement in said air dba-inline 226. Said air inline dfa-door 234 as closed, stopping air from entering said air dba-inline 226.

Said air inline dfa-door 234 as open, used for letting air movement though said air dba-inline 226. Said air inline dfa-door 234 as open, letting air movement to enter said air dba-inline 226. Said air inline dfa-door 234 as open, letting air movement to leave said air dba-inline 226, air inward into said air boa-cylinder 166.

Said air inline door dha-vane 238, attached to end of said air inline dfa-door 234. Said air inline door dha-vane 238, used for air movement outward moving onto and closing said air inline dfa-door 234.

### Air Inline dfa-Door 234

Said air inline dfa-door 234, utilizing member including said air inline dga-hinge 236, said air inline door dha-vane 238. Said air inline dfa-door 234 has, said air inline dga-hinge 236, said air inline door dha-vane 238.

Said air inline dea-chamber 232, said air inline dfa-door 234, said air inline dga-hinge 236, said air inline door dha-vane 238, house within said air dba-inline 226.

Said air inline dea-chamber 232, a open area within said air dba-inline 226. Said air inline dea-chamber 232, a open area used for opening and closing, said air inline dfa-door 234.

Said air dba-inline 226 air movement inward, passes though from said flywheel eba-vane 244, air inward into said air cylinder bpa-chamber 168.

Said air inline dfa-door 234 as closed, used for stopping air movement in said air dba-inline 226. Said air inline dfa-door 234 as closed, stopping air from entering said air dba-inline 226.

Said air inline dfa-door 234 as open, used for letting air movement though said air dba-inline 226. Said air inline dfa-door 234 as open, letting air movement to enter said air dba-inline 226. Said air inline dfa-door 234 as open, letting air movement to leave said air dba-inline 226, air movement onto said flywheel eba-vane 244.

Said air bra-piston 178 on the inward stroke, air drawn into said air cylinder bpa-chamber 168, air drawn from said air inline dda-outlet 230, air drawn from said air dba-inline 226, air pulling and drawing said air inline dfa-door 234 open.

Said air inline door dha-vane 238, attached to end of said air inline dfa-door 234. Said air bra-piston 178 on the outward stroke, air drawn into said air inline dda-outlet 230, air drawn into said air dba-inline 226, than air drawn onto said air inline door dha-vane 238, drawing on and closing said air inline dfa-door 234.

Said air inline dga-hinge 236, used for attaching said air inline dfa-door 234, onto said air dba-inline 226. Said air inline dga-hinge 236, used for opening and closing said air inline dfa-door 234.

### yyy-Flywheel 240

Said yyy-flywheel 240, utilizing member including said outer flywheel eaa-edge 242, said flywheel eba-vane 244.

Said yyy-flywheel 240, has said outer flywheel eaa-edge 242, said flywheel eba-vane 244, said drive eca-shaft 246.

Said yyy-flywheel 240, used for providing the power for driving said drive eca-shaft 246. Said flywheel eba-vane 244, used for providing the power for driving said yyy-flywheel 240. Said yyy-flywheel 240, having said flywheel eba-vane 244 attached. Said flywheel eba-vane 244 attached to said outer flywheel eaa-edge 242, of said yyy-flywheel 240.

Said air ara-piston 172, moves outward toward said yyy-flywheel 240, compressing outgoing air, pushing the air movement outward into said air outline ava-inlet 186, than air outward into said air aua-outline 184. The compressed air from said air aua-outline 184, than air outward enters said air outline awa-outlet 188, than air pushes outward onto said flywheel eba-vane 244, rotating said yyy-flywheel 240 in a rotary motion.

Said air bra-piston 178, moves outward toward said yyy-flywheel 240, compressing outgoing air, pushing the air movement outward into said air outline bva-inlet 200, than air outward into said air bua-outline 198. The compressed air from said air bua-outline 198, than air outward enters said air outline bwa-outlet 202, than air pushes outward onto said flywheel eba-vane 244, attached to said yyy-flywheel 240, rotating said yyy-flywheel 240 in a rotary motion.

Said air ara-piston 172, on the inward stroke move away from said flywheel eba-vane 244, attached to said yyy-flywheel 240. Said air ara-piston 172 within, said air aoa-cylinder 160, draws air movement inward, by using said air ara-piston 172, drawing air off said flywheel eba-vane 244, drawing air inward into said air inline cca-inlet 214, than air inward into said air cba-inline 212, than air inward into said air inline cda-outlet 216, then air inward into said air aoa-cylinder 160. Said flywheel eba-vane 244, is drawn forward by the air being drawn off and into said air inline cca-inlet 214.

Said air bra-piston 178, on the inward stroke move away from said flywheel eba-vane 244, attached to said yyy-flywheel 240.

Said air bra-piston 178 within, said air boa-cylinder 166, draws air movement inward, by using said air bra-piston 178, drawing air off said flywheel eba-vane 244, drawing air inward into said air inline dca-inlet 228, than air inward into said air dba-inline 226, than air inward into said air inline dda-outlet 230, then air inward into said air boa-cylinder 166. Said flywheel eba-vane 244, is drawn forward by the air being drawn off and into said air inline dca-inlet 228.

Said drive eca-shaft 246, attached to said yyy-flywheel 240. Said drive eca-shaft 246 moves within the rotary motion of said yyy-flywheel 240.

### Drive eca-Shaft 246

Said drive eca-shaft 246, utilizing said drive eca-shaft 246, attached to the center of said yyy-flywheel 240.

Said drive eca-shaft 246, has said yyy-flywheel 240, said flywheel eba-vane 244. Said flywheel eba-vane 244, mounted along said outer flywheel eaa-edge 242, of said yyy-flywheel 240. Said flywheel eba-vane 244 is driven and drawn forward by the use of air in a rotary motion. Said drive eca-shaft 246 moves within the rotary motion of said yyy-flywheel 240. Said drive eca-shaft 246 is driven from the continuous rotation of said yyy-flywheel 240. Said drive eca-shaft 246 in the center of said yyy-flywheel 240.

Using compressed air movement to push air onto, on the outward stroke and drawn air in from the inward stroke, onto and from said flywheel eba-vane 244, moving said yyy-flywheel 240 attached in a rotary motion. Said yyy-flywheel 240, attached to said drive eca-shaft 246, rotating said drive eca-shaft 246 in a rotary motion, converting energy into mechanical energy or work.

### Objects and Advantages

Said flywheel vane combustion engine 110 utilization innovations which improve controllability and efficiency of said flywheel vane combustion engine 110 by using and combining with said yyy-flywheel 240. Advantages of a free-piston engine that its piston not being rigidly attached to said drive eca-shaft 246 connected by a rod. Using said www-cylinder 112 housing, said combustion aba-chamber 118 and said combustion bba-chamber 128, with said xxx-piston 138. Advantageous application using, said www-cylinder 112 with, said combustion aba-chamber 118 and said combustion bba-chamber 128, with said xxx-piston 138 within freely moving fore and aft, from said combustion aba-chamber 118 to said combustion bba-chamber 128.

Advantageous application using, said xxx-piston 138 along with, said piston aka-rod 148 and said piston bka-rod 154, attached and extended out though said cylinder aaa-opening 114 and extended out though said cylinder baa-opening 116 each side of said www-cylinder 112. By using compressed air in using, said air aoa-cylinder 160 and said air boa-cylinder 166, said air cylinder apa-chamber 162 and said air cylinder bpa-chamber 168, said air ara-piston 172 and said air bra-piston 178. Pushing air outward onto and drawing air inward off said flywheel eba-vane 244, attached to said yyy-flywheel 240. Rotating said yyy-flywheel 240 in a rotary motion.

This will reduce toxic emissions, weight and size of such engines. Increases energy efficiency by increasing the specific power output, resulting in a smaller engine with less heat and friction losses.

Further objects and advantages of my invention will become apparent. This consideration of the drawing and ensuring description will become apparent.

### Ramifications of Detailed Description

The foregoing discussion and claims that follow describe only preferred embodiments of present invention. These embodiments particularly with respect to the claims. Understood a number of changes might be made without departing from essence present invention. One of these changes could be without departing from essence present invention, by attaching piston aka-rod and attaching piston bka-rod directly to the drive eca-shaft, therefore doing away with the yyy-flywheel or its flywheel eba-vane, and doig away with the air aoa-cylinder, air boa-cylinder, air ara-piston, and the air bra-piston. A other changes could be using a liquid orther than air. It is intended that such changes substantially achieve the same results. Substantially same way will still fall within scope of the present invention.

It is not practical to describe in claims all possible embodiments. Embodiments may be accomplished generally in keeping with present invention. Disclosure may include separately or collectively aspects described found throughout description of patent. While these may be added to explicitly include such details. Existing claims should be construed to encompass such aspects. To the extent methods claimed in present invention are not further discussed. Any extent methods are natural outgrowths of the system or apparatus claims. Therefore, separate and further discussions of the methods are deemed unnecessary. Otherwise claim steps implicit in use and manufacture of system or apparatus claims. Furthermore, steps organized in logical fashion and other sequences can and do occur. Therefore, method claims should not be construed to include only this order. Other order and sequence steps may be presented.

Furthermore, any references mentioned in the application for this patent as well as all references listed. That all and any information disclosure originally filed with the application is hereby incorporated. That all reference in their entirety to the extent such may be deemed essential. That all supports ennoblement of the invention(s). However, to the extent statements might be considered inconsistent with the patenting of this/these invention(s). Any such statements are expressly not to be considered as made by the applicant. Notice: Subject to any disclaimer, the term of this patent is extended or adjusted under 35 U.S.C. 154(b) by 0 days.

What is claim is:

1. Enclosed within flywheel vane combustion engine having yyy-flywheel with www-cylinder that housing combustion aba-chamber and combustion bba-chamber, with www-cylinder being closed at both ends and combustion aba-chamber at one end and combustion bba-chamber at the other end, with www-cylinder mounted near yyy-flywheel, with xxx-piston lying within www-cylinder, with www-cylinder having chamber abb-outlet and chamber bbb-outlet along with ahc-exhaust pipe and bhc-exhaust pipe, with xxx-piston having exhaust holding abd-area with exhaust abc-inlet/outlet also having exhaust holding bbd-area, with exhaust bbc-inlet/outlet, with exhaust holding abd-area at one end of xxx-piston and exhaust holding bbd-area at the other end, with www-cylinder having cylinder aaa-opening for piston aka-rod at one side of www-cylinder and having cylinder baa-opening on the other side of www-cylinder for piston bka-rod and with ahc-exhaust pipe having exhaust afa-inlet at one end and exhaust ahd-outlet at the end, with bhc-exhaust pipe having exhaust bfa-inlet at one end and exhaust bhd-outlet at the end of xxx-piston, with piston aka-rod attached to one side of xxx-piston along with piston bka-rod attached to the other side of xxx-piston, with piston aka-rod attached to xxx-piston at one end and air ara-piston at the other end, with piston bka-rod attached to xxx-piston at one end and air bra-piston at the other end, with air ara-piston enclosed within air aoa-cylinder, with air bra-piston enclosed within air boa-cylinder, with air aoa-cylinder having attached to air aua-outline and also attached to air cba-inline, with air boa-cylinder having attached to air bua-outline and also attached to air dba-inline, with air aua-outline having air outline ava-inlet and also having air outline awa-outlet, with air cba-inline having air inline cca-inlet and also having air inline cda-outlet, with air bua-outline having air outline bva-inlet and also having air outline bwa-outlet, with air dba-inline having air inline dca-inlet and also having air inline dda-outlet, with air outline ava-inlet attached to air aoa-cylinder at one end and air outline awa-outlet that mounted at periphery of flywheel eba-vane at the other end, with air inline cca-inlet that mounted at periphery of flywheel eba-vane and air inline cda-outlet attached to air aoa-cylinder at one end, with air outline bva-inlet attached to air boa-cylinder at one end and air outline bwa-outlet that mounted at periphery of flywheel eba-vane at the other end, with air inline dca-inlet that mounted at periphery of flywheel eba-vane and air inline dda-outlet attached to air aoa-cylinder at one end, with air aua-outline having air outline aya-door along with air outline aza-hinge house within air aua-outline, with air bua-outline having air outline bya-door along with air outline bza-hinge house within air bua-outline, with air cba-inline having air inline cfa-door along with air inline cga-hinge house within air cba-inline, with air dba-inline having air inline dfa-door along with air inline dga-hinge house within air dba-inline, with yyy-flywheel at outer flywheel eaa-edge being attached flywheel eba-vane, with yyy-flywheel having drive eca-shaft at the center of yyy-flywheel, with flywheel eba-vane lying at the at periphery of air outline awa-outlet, with air inline cca-inlet, with air outline bwa-outlet and air inline dca-inlet, with combustion aba-chamber has aca-sensor, with ada-injector, with spark aea-plug, with chamber abb-outlet, with aca-sensor measuring to determine the fuel pumping through ada-injector, with ada-injector admitting air-fuel inside, with spark aea-plug delivering a spark igniting the mix within combustion aba-chamber, with combustion bba-chamber has, with bca-sensor, with bda-injector, with spark bea-plug, with chamber bbb-outlet, with bca-sensor measuring to determine the fuel pumping through bda-injector, with bda-injector admitting air-fuel inside, with spark bea-plug delivering a spark igniting the mix within combustion bba-chamber, with piston aga-ring is fitting around xxx-piston, therefore stopping combustion gases movement from leaving combustion aba-chamber, with piston bga-ring is fitting around xxx-piston, therefore stopping combustion gases movement from leaving combustion bba-chamber, with air piston asa-ring is fitting around air ara-piston, therefore stopping air movement from leaving air aoa-cylinder, with air piston bsa-ring is fitting around air bra-piston, therefore stopping air movement from leaving air boa-cylinder, with air aua-outline having air outline aya-door as open letting the air flow within air aua-outline and as close stopping air flow within air aua-outline, with air cba-inline having air inline cfa-door as open letting the air flow within air cba-inline and as close stopping air flow within air cba-inline, with air bua-outline having air outline bya-door as open letting the air flow within air bua-outline and as close stopping air flow within air bua-outline, with air dba-inline having air inline dfa-door as open letting the air flow within air dba-inline and as close stopping air flow within air dba-inline, with air outline aza-hinge is used for attaching air outline aya-door onto air aua-outline, with air outline bza-hinge is used for attaching air outline bya-door onto air bua-outline, with air inline cga-hinge is used for attaching air inline cfa-door onto air cba-inline, with air inline dga-hinge is used for attaching air inline dfa-door onto air dba-inline.

2. The combination as set forth in claim 1 wherein said flywheel vane combustion engine having www-cylinder that housing combustion aba-chamber and combustion bba-chamber, with www-cylinder being closed at both ends and combustion aba-chamber at one end and combustion bba-chamber at the other end, with www-cylinder mounted near yyy-flywheel, with xxx-piston lying within www-cylinder, with www-cylinder having chamber abb-outlet and chamber bbb-outlet along with ahc-exhaust pipe and bhc-exhaust pipe, with xxx-piston having exhaust holding abd-area with exhaust abc-inlet/outlet also having exhaust holding bbd-area, with exhaust bbc-inlet/outlet, with exhaust holding abd-area at one end of xxx-piston and exhaust holding bbd-area at the other end, with www-cylinder having cylinder aaa-opening for piston aka-rod at one side of www-cylinder and having cylinder baa-opening on the other side of www-cylinder for piston bka-rod and with ahc-exhaust pipe having exhaust afa-inlet at one end and exhaust ahd-outlet at the end, with bhc-exhaust pipe having exhaust bfa-inlet at one end and exhaust bhd-outlet at the end of xxx-piston, with piston aka-rod attached to one side of xxx-piston along with piston bka-rod attached to the other side of xxx-piston.

3. The combination as set forth in claim 1 wherein said flywheel vane combustion engine having piston aka-rod attached to xxx-piston at one end and air ara-piston at the other end, with piston bka-rod attached to xxx-piston at one end and air bra-piston at the other end, with air ara-piston enclosed within air aoa-cylinder, with air bra-piston enclosed within air boa-cylinder, with air aoa-cylinder having attached to air aua-outline and also attached to air cba-inline, with air boa-cylinder having attached to air bua-outline and also attached to air dba-inline, with air aua-outline having air outline//-ava-inlet and also having air outline awa-outlet, with air cba-inline having air inline cca-inlet and also having air inline cda-outlet, with air bua-outline having air outline bva-inlet and also having air outline bwa-outlet, with air dba-inline having air inline dca-inlet and also having air inline dda-outlet, with air outline ava-inlet attached to air aoa-cylinder at one end and air outline awa-outlet that mounted at periphery of flywheel eba-vane at the other end, with air inline cca-inlet that mounted at periphery of flywheel eba-vane and air inline cda-outlet attached to air aoa-cylinder at one end, with air outline bva-inlet attached to air boa-cylinder at one end and air outline bwa-outlet that mounted at periphery of flywheel eba-vane at the other end, with air inline dca-inlet that mounted at periphery of flywheel eba-vane and air inline dda-outlet attached to air aoa-cylinder at one end, with air aua-outline having air outline aya-door along with air outline aza-hinge house within air aua-outline, with air bua-outline having air outline bya-door along with air outline bza-hinge house within air bua-outline, with air cba-inline having air inline cfa-door along with air inline cga-hinge house within air cba-inline, with air dba-inline having air inline dfa-door along with air inline dga-hinge house within air dba-inline, with yyy-flywheel at outer flywheel eaa-edge being attached flywheel eba-vane, with yyy-flywheel having drive eca-shaft at the center of yyy-flywheel, with flywheel eba-vane lying at the at periphery of air outline awa-outlet, with air inline cca-inlet, with air outline bwa-outlet and air inline dca-inlet, with air piston asa-ring is fitting around air ara-piston, therefore stopping air movement from leaving air aoa-cylinder, with air piston bsa-ring is fitting around air bra-piston, therefore stopping air movement from leaving air boa-cylinder, with air aua-outline having air outline aya-door as open letting the air flow within air aua-outline and as close stopping air flow within air aua-outline, with air cba-inline having air inline cfa-door as open letting the air flow within air cba-inline and as close stopping air flow within air cba-inline, with air bua-outline having air outline bya-door as open letting the air flow within air bua-outline and as close stopping air flow within air bua-outline, with air dba-inline having air inline dfa-door as open letting the air flow within air dba-inline and as close stopping air flow within air dba-inline, with air outline aza-hinge is used for attaching air outline aya-door onto air aua-outline, with air outline bza-hinge is used for attaching air outline bya-door onto air bua-outline, with air inline cga-hinge is used for attaching air inline cfa-door onto air cba-inline, with air inline dga-hinge is used for attaching air inline dfa-door onto air dba-inline.

4. An engine as set forth in claim 1, wherein said www-cylinder housing combustion aba-chamber and combustion bba-chamber, closed at both ends with combustion aba-chamber at one end and combustion bba-chamber at the other end, with chamber abb-outlet near one end and chamber bbb-outlet near the other end, with cylinder aaa-opening and with cylinder baa-opening and with exhaust afa-inlet near one end and exhaust bfa-inlet near the other end and aca-sensor with ada-injector with spark aea-plug at one end with bca-sensor and bda-injector and spark bea-plug at the other end.

5. An engine as set forth in claim 1, wherein said www-cylinder housing combustion aba-chamber and combustion bba-chamber, closed at both ends with combustion aba-chamber at one end and combustion bba-chamber at the other end.

6. An engine as set forth in claim 1, wherein said xxx-piston with exhaust holding abd-area and exhaust abc-inlet/outlet at one end and exhaust holding bbd-area and exhaust bbc-inlet/outlet at the other end and piston aia-head at one end and piston bia-head at the other end and piston aga-ring at one end and piston bga-ring at the other end and with rod ama-point and rod bma-point.

7. An engine as set forth in claim 1, wherein said chamber abb-outlet within www-cylinder.

8. An engine as set forth in claim 1, wherein said chamber bbb-outlet within www-cylinder.

9. An engine as set forth in claim 1, wherein said cylinder aaa-opening into www-cylinder.

10. An engine as set forth in claim 1, wherein said cylinder baa-opening into www-cylinder.

11. An engine as set forth in claim 1, wherein said exhaust holding abd-area within xxx-piston with exhaust abc-inlet/outlet.

12. An engine as set forth in claim 1, wherein said exhaust holding bbd-area within xxx-piston with exhaust bbc-inlet/outlet.

13. An engine as set forth in claim 1, wherein said air aoa-cylinder housing air cylinder apa-chamber which has air cylinder aqa-opening and air outline ava-inlet and air inline cda-outlet and housing within said air aoa-cylinder would be air ara-piston attached to piston aka-rod.

14. An engine as set forth in claim 1, wherein said air boa-cylinder housing air cylinder bpa-chamber which has air cylinder bqa-opening and air outline bva-inlet and air inline dda-outlet and housing within said air boa-cylinder would be air bra-piston attached to piston bka-rod.

15. An engine as set forth in claim 1, wherein said air aua-outline which has air outline ava-inlet and air outline awa-outlet with air outline axa-chamber and housing within air outline axa-chamber the air outline aya-door with its air outline aza-hinge and its air outline door caa-vane.

16. An engine as set forth in claim 1, wherein said air outline aya-door with its air outline aza-hinge and its air outline door caa-vane being house within air outline axa-chamber.

17. An engine as set forth in claim 1, wherein said air bua-outline which has air outline bva-inlet and air outline bwa-outlet with air outline bxa-chamber and housing within air outline bxa-chamber the air outline bya-door with its air outline bza-hinge and its air outline door daa-vane.

18. An engine as set forth in claim 1, wherein said air outline bya-door with its air outline bza-hinge and its air outline door daa-vane being house within air outline bxa-chamber.

19. An engine as set forth in claim 1, wherein said air cba-inline which has air inline cca-inlet and air inline cda-outlet with air inline cea-chamber and housing within air inline cea-chamber the air inline cfa-door with its air inline cga-hinge and its air inline door cha-vane.

20. An engine as set forth in claim 1, wherein said air inline cfa-door with its air inline cga-hinge and its air inline door cha-vane being house within air inline cea-chamber.

21. An engine as set forth in claim 1, wherein said air dba-inline which has air inline dca-inlet and air inline dda-outlet with air inline dea-chamber and housing within air inline dea-chamber the air inline dfa-door with its air inline dga-hinge and its air inline door dha-vane.

22. An engine as set forth in claim 1, wherein said air inline dfa-door with its air inline dga-hinge and its air inline door dha-vane being house within air inline dea-chamber.
